(19) United States
(12) Patent Application Publication
(10) Pub. No.: US 2010/0189365 A1
(43) Pub. Date: Jul. 29, 2010

(54) Imaging apparatus, retrieval method, and program

(75) Inventor: Yukiko Kanekiyo, Tokyo (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/657,822

(22) Filed: Jan. 28, 2010

(30) Foreign Application Priority Data
Jan. 29, 2009 (JP) P2009-017633

(51) Int. Cl. G06K 9/62

(52) U.S. Cl. 382/209

(57) ABSTRACT

An imaging apparatus includes an image acquisition mechanism configured to acquire an image by imaging a subject to output an acquired image; an acquired image characteristic amount extraction mechanism configured to extract a characteristic amount of the acquired image acquired by the image acquisition mechanism; and a retrieval mechanism configured to retrieve images of which the characteristics are identical or similar to the characteristics of the acquired image from other images other than the acquired image using the characteristic amount extracted by the acquired image characteristic amount extraction mechanism.

### BACKGROUND OF THE INVENTION

1. Field of the Invention

The present invention relates to an imaging apparatus, a retrieval method, and a program, and more particularly, to an imaging apparatus, a retrieval method, and a program capable of enabling a desired image to be retrieved more easily.

2. Description of the Related Art

In recent years, electronic devices (imaging apparatuses), such as digital cameras or camcorders, which image a subject with the aid of imaging elements to acquire subject images have been popularized. Such imaging apparatuses are generally equipped with a large-capacity storage medium such as a hard disk, a semiconductor memory, or a tape device, are configured to be capable of mounting a removable medium (portable storage medium) such as, an optical disc or a memory card, or are connected to an external recording device. The imaging apparatuses convert subject images (acquired images) into electronic data by imaging a subject and store the image data in such a storage medium.

With the trend toward storage media with higher capacity and higher recording density, it has become possible to buy a cheap storage medium with large capacity and small size. In addition, an imaging apparatus capable of storing image data (acquired images) of several hundreds or thousands of images in a storage medium has begun to appear on the market.

The image data stored thus are transferred to a personal computer and edited, printed or distributed via an electronic mail by users, for example. The image data are also displayed on a display unit such as an LCD (liquid crystal display) which is provided to the imaging apparatus. For example, the imaging apparatus usually has an imaging mode where a process is performed for imaging a subject to generate image data of the acquired image and a viewer mode where a process is performed for allowing users to browse image data which have been generated in the past. In such an imaging apparatus, when a user selects the viewer mode, the imaging apparatus allows the user to select desired data among the image data stored in the storage medium and displays the image data selected by the user on the display unit.

For example, there is known a method in which the imaging apparatus displays a list of thumbnail images of the image data stored in the storage medium to be selected by the user (see Japanese Unexamined Patent Application Publication No. 2006-011606 (corresponding to US Patent Application Publication No. 2006-165380A1), for example). When the user selects a desired thumbnail image in the list, the imaging apparatus reads image data corresponding to the selected thumbnail image from the storage medium and displays the image on the display unit.

### SUMMARY OF THE INVENTION

However, when the imaging apparatus has a large-capacity storage medium, the user may have to select the desired image from a large quantity of image data. Furthermore, when the imaging apparatus transfers image data to a server and the like to register them in a database, the user may have to select the desired image from a much larger quantity of images. In such a case, with the method of presenting a list of thumbnail images as disclosed in Japanese Unexamined Patent Application Publication No. 2006-011606 (corresponding to US Patent Application Publication No. 2006-165380A1), it may be difficult to allow the user to select the desired image without difficulties.

It is therefore desirable to enable a desired image to be retrieved more easily from a large quantity of images.

An imaging apparatus according to a first embodiment of the present invention includes image acquisition means for acquiring an image by imaging a subject to output an acquired image; acquired image characteristic amount extraction means for extracting a characteristic amount of the acquired image acquired by the image acquisition means; and retrieval means for retrieving images of which the characteristics are identical or similar to the characteristics of the acquired image from other images other than the acquired image using the characteristic amount extracted by the acquired image characteristic amount extraction means.

The retrieval means may include retrieval target image acquisition means for acquiring the other images as retrieval target images; retrieval target image characteristic amount acquisition means for extracting a characteristic amount of the retrieval target images acquired by the retrieval target image acquisition means; and comparing means for comparing the characteristic amount of the acquired image and the characteristic amount of the retrieval target images.

The imaging apparatus may further include receiving means for receiving a user's instruction, and the image acquisition means may image the subject in accordance with the user's instruction.

The imaging apparatus may further includes image analysis means for analyzing the acquired image, and the image acquisition means may image the subject in accordance with the analysis results of the image analysis means.

The imaging apparatus may further include area specifying means for specifying a partial area for which the characteristic amount is compared, and the retrieval means may retrieve images of which the characteristics in the partial area are identical or similar to the characteristics of the acquired image from the other images using the characteristic amount in the partial area.

The imaging apparatus may further include receiving means for receiving a user's instruction, and the area specifying means may set areas having predetermined characteristics as candidates for the partial area based on the characteristic amount extracted by the acquired image characteristic amount extraction means and specify an area selected from the candidates by the user's instruction as the partial area.

The area specifying means may specify the partial area having predetermined characteristics based on the characteristic amount extracted by the acquired image characteristic amount extraction means.

The imaging apparatus may further include receiving means for receiving a user's instruction, and the area specifying means may specify an area designated by the user's instruction as the partial area.

The imaging apparatus may further include result displaying means for displaying a result of the retrieval by the retrieval means.

The imaging apparatus may further include re-retrieval means for retrieving images of which the characteristics are identical or similar to the characteristics of the acquired image from the images retrieved by the retrieval means using another characteristic amount.

A retrieval means according to the first embodiment of the present invention includes the steps of: acquiring an image by imaging a subject to output an acquired image; extracting a characteristic amount of the acquired image; and retrieving images of which the characteristics are identical or similar to the characteristics of the acquired image from other images other than the acquired image using the characteristic amount.

A program according to the first embodiment of the present invention causes a computer to execute a retrieval method including the steps of: acquiring an image by imaging a subject to output an acquired image; extracting a characteristic amount of the acquired image; and retrieving images of which the characteristics are identical or similar to the characteristics of the acquired image from other images other than the acquired image using the characteristic amount.

An imaging apparatus according to a second embodiment of the present invention includes image acquisition means for acquiring an image by imaging a subject to output an acquired image; extraction means for extracting a characteristic amount of the acquired image acquired by the image acquisition means; supplying means for supplying the characteristic amount extracted by the extraction means to another apparatus; and acquisition means for acquiring results of retrieval for images of which the characteristics are identical or similar to the characteristics of the acquired image, the retrieval being performed by the other apparatus using the characteristic amount supplied by the supplying means.

A retrieval method according to the second embodiment of the present invention includes the steps of: acquiring an image by imaging a subject to output an acquired image; extracting a characteristic amount of the acquired image; supplying the extracted characteristic amount to another apparatus; and acquiring results of retrieval for images of which the characteristics are identical or similar to the characteristics of the acquired image, the retrieval being performed by the other apparatus using the characteristic amount.

A program according to the second embodiment of the present invention causes a computer to execute a retrieval method including the steps of: acquiring an image by imaging a subject to output an acquired image; extracting a characteristic amount of the acquired image; supplying the extracted characteristic amount to another apparatus; and acquiring results of retrieval for images of which the characteristics are identical or similar to the characteristics of the acquired image, the retrieval being performed by the other apparatus using the characteristic amount.

An imaging apparatus according to a third embodiment of the present invention includes first image acquisition means for acquiring an image by imaging a subject to output an acquired image; extraction means for extracting a characteristic amount of the acquired image acquired by the first image acquisition means; second image acquisition means for acquiring images of image data stored in another apparatus as retrieval target images; and retrieval means for retrieving images of which the characteristics are identical or similar to the characteristics of the acquired image from the images of the image data acquired by the second image acquisition means using the characteristic amount extracted by the extraction means.

A retrieval method according to the third embodiment of the present invention includes the steps of: acquiring an image by imaging a subject to output an acquired image; extracting a characteristic amount of the acquired image; acquiring images of image data stored in another apparatus as retrieval target images; retrieving images of which the characteristics are identical or similar to the characteristics of the acquired image from the acquired images of the image data using the extracted characteristic amount.

A program according to the third embodiment of the present invention causes a computer to execute a retrieval method including the steps of: acquiring an image by imaging a subject to output an acquired image; extracting a characteristic amount of the acquired image; acquiring images of image data stored in another apparatus as retrieval target images; retrieving images of which the characteristics are identical or similar to the characteristics of the acquired image from the acquired images of the image data using the extracted characteristic amount.

According to the first embodiment of the present invention, the image is acquired by imaging a subject to output an acquired image, the characteristic amount of the acquired image is extracted, and images of which the characteristics are identical or similar to the characteristics of the acquired image are retrieved from other images of image data other than the acquired image using the extracted characteristic amount.

According to the second embodiment of the present invention, the image is acquired by imaging a subject to output an acquired image, the characteristic amount of the acquired image is extracted, the extracted characteristic amount is supplied to another apparatus, and the results of retrieval for images of which the characteristics are identical or similar to the characteristics of the acquired image are acquired, where the retrieval is performed by the apparatus using the characteristic amount.

According to the third embodiment of the present invention, the image is acquired by imaging a subject to output an acquired image, the characteristic amount of the acquired image is extracted, images of image data stored in another apparatus are acquired as retrieval target images, and images of which the characteristics are identical or similar to the characteristics of the acquired image are retrieved from the acquired images of the image data using the extracted characteristic amount.

According to the embodiments of the present invention, it is possible to process information. In particular, it is possible to retrieve a desired image more easily.

### BRIEF DESCRIPTION OF THE DRAWINGS

FIG. 1 is a schematic diagram illustrating an overview of an imaging apparatus according to an embodiment of the present invention.

FIG. 2 is a block diagram illustrating an example of the main configuration of the imaging apparatus according to the embodiment of the present invention.

FIG. 3 is a schematic diagram illustrating an exemplary mode configuration.

FIG. 4 is a block diagram illustrating an example of the main configuration of an imaging retrieval unit.

FIG. 5 is a block diagram illustrating an example of the main configuration of a selective retrieval unit.

FIG. 6 is a flowchart illustrating a mode selection process.

FIG. 7 is a flowchart illustrating an imaging retrieval process.

FIG. 8 is a flowchart illustrating a selective retrieval process.

FIGS. 9A to 9C are schematic diagrams illustrating a method of displaying retrieval results.

FIGS. 10A to 10C are schematic diagrams illustrating a method of displaying retrieval results.

FIGS. 11A to 11C are schematic diagrams illustrating a method of displaying retrieval results.

FIGS. 12A to 12C are schematic diagrams illustrating a method of displaying retrieval results.

FIG. 13 is a block diagram illustrating a modified example of the configuration of the imaging retrieval unit.

FIG. 14 is a flowchart illustrating the imaging retrieval process.

FIG. 15 is a flowchart illustrating the imaging retrieval process.

FIGS. 16A to 16C are schematic diagrams illustrating a method of specifying areas.

FIG. 17 is a flowchart illustrating the imaging retrieval process.

FIG. 18 is a flowchart illustrating the imaging retrieval process.

FIGS. 19A to 19C are schematic diagrams illustrating a method of displaying retrieval results.

FIG. 20 is a flowchart illustrating the imaging retrieval process.

FIG. 21 is a schematic diagram illustrating an overview of an image retrieval system according to an embodiment of the present invention.

FIG. 22 is a block diagram illustrating an example of the main configuration of each apparatus.

FIG. 23 is a flowchart illustrating an image retrieval process.

FIG. 24 is a block diagram illustrating a modified example of the configuration of each apparatus.

FIG. 25 is a flowchart illustrating the image retrieval process.

FIG. 26 is a block diagram illustrating the main configuration of each apparatus according to another embodiment.

FIG. 27 is a block diagram illustrating a modified example of the configuration of each apparatus.

FIG. 28 is a flowchart illustrating the image retrieval process.

### DESCRIPTION OF THE PREFERRED EMBODIMENTS

Hereinafter, modes (hereinafter referred to as embodiments) for carrying out the present invention will be described. The description will be given in the following order:

1. First Embodiment (Imaging Retrieval: Image Retrieval Within Imaging Apparatus);

2. Second Embodiment (Imaging Retrieval: Image Retrieval on Network); and

3. Third Embodiment (Imaging Retrieval: Server-Based Image Retrieval on Network)

### 1. First Embodiment

### Overview of Imaging Apparatus

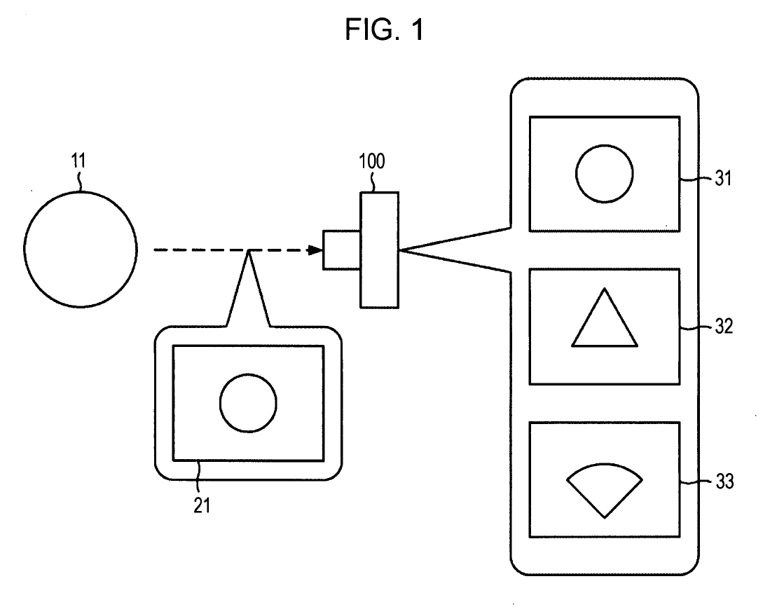

FIG. 1 is a schematic diagram illustrating an overview of an imaging apparatus according to an embodiment of the present invention.

An imaging apparatus 100 acquires an image by imaging a subject 11 to output an acquired image, converts the subject image (acquired image) into electronic data, and stores image data obtained thus in a storage medium incorporated therein. The imaging apparatus 100 is an electronic equipment such as a digital camera or a camcorder. In FIG. 1, images 31 to 33 represent images of image data which are generated and stored in the storage medium.

The imaging apparatus 100 includes a display device (display unit) such as an LCD (liquid crystal display). In the viewer mode, the imaging apparatus 100 allows a user to select a desired image from the images (images 31 to 33) of the image data stored in the storage medium and displays the selected image on the display unit.

The imaging apparatus 100 has a function of retrieving images using a key image from the images of the image data stored in the storage medium, the retrieved images being identical or similar to the key image. Although the key image may be selected from the images of the image data stored in the storage medium, the imaging apparatus 100 may use an image 21 which is newly acquired by imaging as the key image.

For example, when the user operates the imaging apparatus 100 to image the subject 11, the imaging apparatus 100 uses the acquired image 21 as the key image and retrieves images having characteristics identical or similar to those of the key image from the images 31 to 33. Then, the imaging apparatus 100 displays retrieved images (images having characteristics identical or similar to those of the key image) on the display unit as retrieval results.

In the case of the example of FIG. 1, the image 31 has similar characteristics as the acquired image 21 used as the key image. Thus, the imaging apparatus 100 displays the image 31 on the display unit as the retrieval result.

In this way, by performing image retrieval using the characteristics of the key image, the imaging apparatus 100 is able to retrieve a desired image of the user more easily.

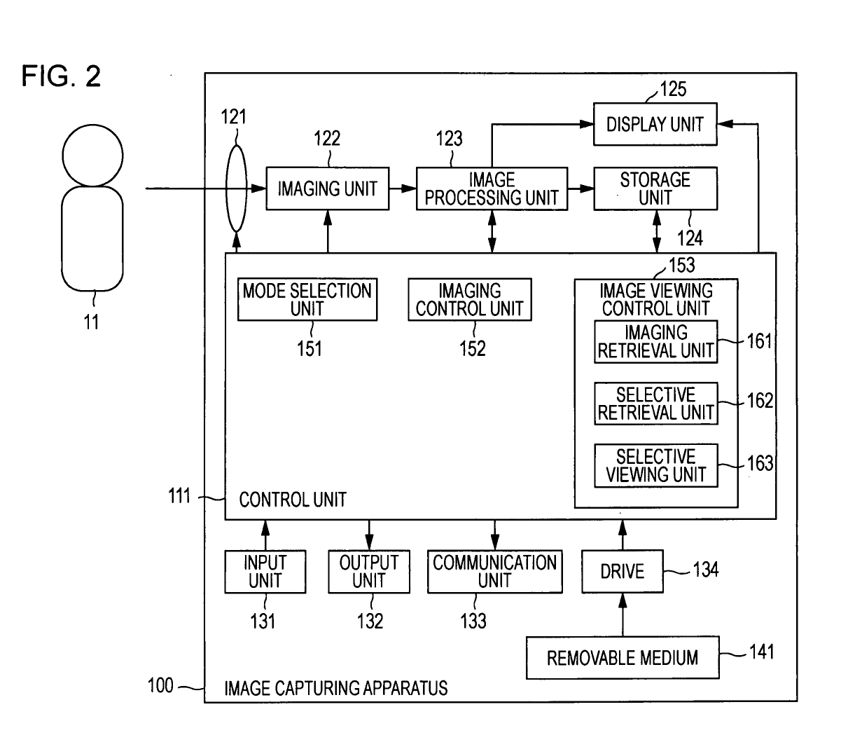

FIG. 2 is a block diagram illustrating an example of the main configuration of the imaging apparatus 100 according to the embodiment of the present invention.

As illustrated in FIG. 2, the imaging apparatus 100 includes a control unit 111, an optical unit 121, an imaging unit 122, an image processing unit 123, a storage unit 124, a display unit 125, an input unit 131, an output unit 132, a communication unit 133, and a drive 134.

The optical unit 121 includes optical elements such as, for example, a lens, an aperture, and a mechanical shutter and adjusts a focal position and exposure. In the imaging mode, the optical unit 121 allows light incident from the outside of the imaging apparatus 100 to pass therethrough to be supplied to the imaging unit 122. The imaging unit 122 includes photoelectric elements such as a CCD (charge coupled device) sensor or a CMOS (complementary metal oxide semiconductor) sensor. The imaging unit 122 converts the incident light (acquired image) supplied via the optical unit 121 into electronic data with the aid of the photoelectric elements, thus generating image data of the acquired image. The imaging unit 122 supplies the generated image data to the image processing unit 123.

The image processing unit 123 performs predetermined image processing on the image data supplied from the imaging unit 122 so as to perform processing such as image quality adjustment or image size control. The image processing unit 123 supplies the processed image data to the storage unit 124, for example, to be stored therein. Moreover, the image processing unit 123 supplies the processed image data to the display unit 125, for example, to be displayed thereon. Furthermore, the image processing unit 123 supplies the processed image data to the control unit 111, for example, to be used for processes executed in the control unit 111.

The storage unit 124 is a storage medium storing the image data and stores therein the image data which are supplied from the image processing unit 123 or the control unit 111. Moreover, the storage unit 124 supplies the image data stored therein to the control unit 111 or the like, as necessary. The storage unit 124 includes an arbitrary type of storage media such as, for example, a magnetic recording medium (e.g., a flexible disk, a tape device, and a hard disk), an optical disc (e.g., a CD (compact disc), and a DVD (digital versatile disc)), and a semiconductor memory (e.g., a flash memory, a SRAM (static random access memory), a DRAM (dynamic random access memory)).

It should be noted that the storage medium may be a removable storage medium, such as a CD or a DVD, which is removable from the storage unit 124. In such a case, the storage unit 124 is configured to include the removable storage medium and a drive on which the removable medium is mounted. The drive is a device which is capable of reading/writing information from/to the removable medium mounted thereon.

The storage unit 124 is not limited to any particular type as long as it is capable of storing image data, and the storage unit 124 may store information to other devices other than the described ones.

The display unit 125 displays images of the image data supplied from the image processing unit 123 or the control unit 111, and GUIs (graphical user interfaces). The display unit 125 includes an arbitrary type of display such as an LCD, a PDP (plasma display panel), an organic EL (electroluminescent) display, or a CRT (cathode ray tube) display. The display unit 125 is not limited to any particular type as long as it is capable of displaying images, and the display unit 125 may display information on other devices other than the described ones. Furthermore, for example, a transparent touch panel for receiving a user's instructions or the like may be embedded onto a display surface of the display unit 125.

The control unit 111 includes a CPU (central processing unit), a ROM (read only memory), a RAM (random access memory), and the like, and performs various processes for controlling the operation of the imaging apparatus 100. The control unit 111 loads programs or data that the CPU reads from the ROM onto the RAM and executes the programs or data, thus realizing various functions of the imaging apparatus 100. For example, the control unit 111 includes functional blocks that include a mode selection unit 151, an imaging control unit 152, and an image viewing control unit 153. These functional blocks are realized when the control unit 111 executes programs.

The programs or data which are loaded onto the RAM may be read from the storage unit 124 and may be read from the removable medium 141 that is mounted on the drive 134.

The mode selection unit 151 selects an operation mode of the imaging apparatus 100. As will be described later, the imaging apparatus 100 has a plurality of operation modes such as, for example, an imaging mode and a viewer mode, and changes processes (functions to be realized) to be executed depending on the operation mode.

The imaging control unit 152 performs a process for realizing the functions of the imaging mode, such as a process of imaging a subject to generate image data, for example. The imaging control unit 152 executes the processes of the imaging mode by controlling mainly each of the units 121 to 125 (the optical unit 121 to the display unit 125) and controlling appropriately each of the units 131 to 134 (the input unit 131 to the drive 134).

The image viewing control unit 153 performs a process for realizing the functions of the viewer mode of allowing users to browse acquired images which have been recorded, such as, for example, a process of reading image data from the storage unit 124 and displaying the images on the display unit 125. The image viewing control unit 153 executes the processes of the viewer mode by controlling mainly each of the units 121 to 125 (the optical unit 121 to the display unit 125) and controlling appropriately each of the units 131 to 134 (the input unit 131 to the drive 134). The image viewing control unit 153 includes an imaging retrieval unit 161, a selective retrieval unit 162, and a selective viewing unit 163.

The imaging retrieval unit 161 performs a process for realizing the functions of a pickup retrieval mode included in the viewer mode. The imaging retrieval unit 161 performs an imaging retrieval-related process of imaging a subject and retrieving a desired image (image data) from images of the image data stored in the storage unit 124 using the acquired image as a key image, for example. The imaging retrieval unit 161 executes the processes of the pickup retrieval mode by controlling mainly each of the units 121 to 125 (the optical unit 121 to the display unit 125) and controlling appropriately each of the units 131 to 134 (the input unit 131 to the drive 134).

The selective retrieval unit 162 performs a process for realizing the functions of a selective retrieval mode included in the viewer mode. The selective retrieval unit 162 performs a selective retrieval-related process of retrieving a desired image (image data) from images of the image data stored in the storage unit 124 using, as a key image, an image (acquired image) of the image data stored in the storage unit 124, the image being selected by a user, for example. The selective retrieval unit 162 executes the processes of the selective retrieval mode by controlling mainly each of the units 123 to 125 (the image processing unit 123 to the display unit 125) and controlling appropriately each of the units 131 to 134 (the input unit 131 to the drive 134).

The selective viewing unit 163 performs a process for realizing the functions of a selective viewing mode included in the viewer mode. The selective viewing unit 163 performs a selective viewing-related process of displaying a list of thumbnail images of the image data stored in the storage unit 124 on the display unit 125, reading image data corresponding to thumbnail images selected by a user from the storage unit 124, and displaying the images on the display unit 125, for example. The selective viewing unit 163 executes the processes of the selective viewing mode by controlling mainly each of the units 123 to 125 (the image processing unit 123 to the display unit 125) and controlling appropriately each of the units 131 to 134 (the input unit 131 to the drive 134).

Each block is able to transmit/receive signals (data) to/from any of the other blocks, as necessary.

The input unit 131 receives instruction inputs upon being operated by a user and supplies the instruction inputs to the control unit 111. The input unit 131 includes buttons, dials, switches, and a touch panel, for example. The input unit 131 may further include other input devices besides the above-mentioned elements.

The output unit 132 outputs information supplied from the control unit 111 to an external device connected to the imaging apparatus 100. The output unit 132 includes a speaker outputting voices, a monitor other than the display unit 125 for displaying images, characters, or the like, output terminals for outputting information via LEDs (light emitting diodes) or electrical signals that indicate the states of the apparatus, for example. The output unit 132 may further include other output devices besides the above-mentioned elements.

The communication unit 133 establishes wired or wireless communication based on predetermined communication protocols with a communication unit of another apparatus other than the imaging apparatus 100 so as to provide information supplied from the control unit 111 to the other apparatus or acquire information supplied from the other apparatus to supply the information to the control unit 111. The communication unit 133 performs communication based on any communication protocols such as, for example, Ethernet (registered trademark), IEEE (Institute of Electrical and Electronic Engineers) 802.11, Bluetooth, USB (universal serial bus), IEEE1394, and HDMI (high-definition multimedia interface).

The drive 134 drives the removable medium 141 such as a magnetic disc, an optical disc, an opto-magnetic disc, or a semiconductor memory. The drive 134 reads programs or data from the removable medium 141 mounted thereon and supplies them to the control unit 111. The drive 134 may be configured as a device that is separated from the imaging apparatus 100 so as to be appropriately connected to the imaging apparatus when the imaging apparatus 100 reads information stored in the removable medium 141.

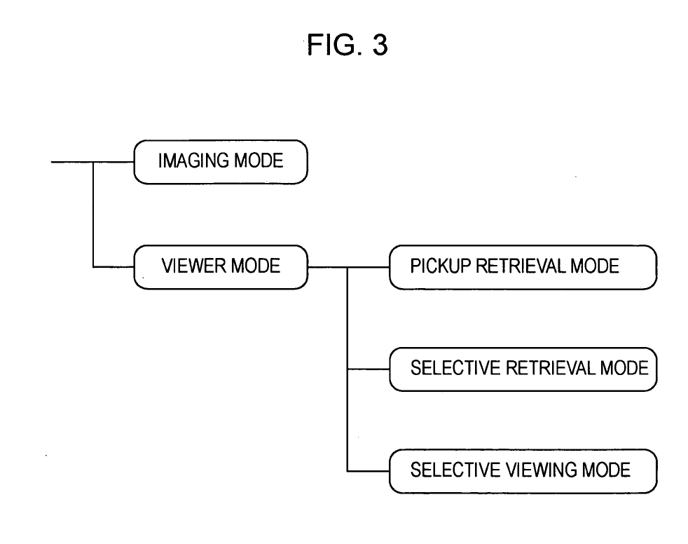

Next, the configuration of the operation mode of the imaging apparatus 100 will be described. FIG. 3 is a schematic diagram illustrating an exemplary mode configuration.

As illustrated in FIG. 3, the operation mode of the imaging apparatus 100 includes an imaging mode where a subject is imaged and image data generated thus are stored or displayed and a viewer mode where images of the image data which have been generated in the past and stored in the storage unit 124 are displayed. The viewer mode includes a pickup retrieval mode, a selective retrieval mode, and a selective viewing mode.

In the pickup retrieval mode, using a characteristic amount of an acquired image as a retrieval key, the imaging retrieval unit 161 retrieves images of which the characteristic amounts are identical or similar to the characteristic amount of the acquired image from the images of the image data stored in the storage unit 124, and the retrieved images are displayed on the display unit 125. That is to say, the retrieval is performed using the acquired image as a key image, and the retrieval results are displayed. Thus, for the user to retrieve a desired image, it is only necessary to perform imaging so as to obtain images of which the characteristics are identical or similar to the characteristics of the desired image. Therefore, the user is able to retrieve the desired image more simply.

In the selective retrieval mode, using a characteristic amount of an image selected by the user as a retrieval key among the images of the image data stored in the storage unit 124, the selective retrieval unit 162 retrieves images of which the characteristic amounts are identical or similar to the characteristic amount of the image selected by the user from the images of the image data stored in the storage unit 124, and the retrieved images are displayed on the display unit 125. That is to say, the retrieval is performed using the image selected by the user as a key image, and the retrieval results are displayed. Thus, for the user to retrieve a desired image, it is only necessary to select images of which the characteristics are identical or similar to the characteristics of the desired image. Therefore, the user is able to retrieve the desired image more simply.

In the selective viewing mode, the selective viewing unit 163 allows the user to select images of the image data stored in the storage unit 124, and the selected images are displayed on the display unit 125. For example, the selective viewing unit 163 displays a list of thumbnail images of the image data stored in the storage unit 124 on the display unit 125 so as to assist in the image selection by the user.

As described above, since different control is performed based on the operation mode, the control unit 111 is easily able to prevent power from being supplied to unnecessary processors (that is, power control is made easy). Thus, it is possible to reduce power consumption of the imaging apparatus 100.

### Exemplary Configuration of Imaging Retrieval Unit

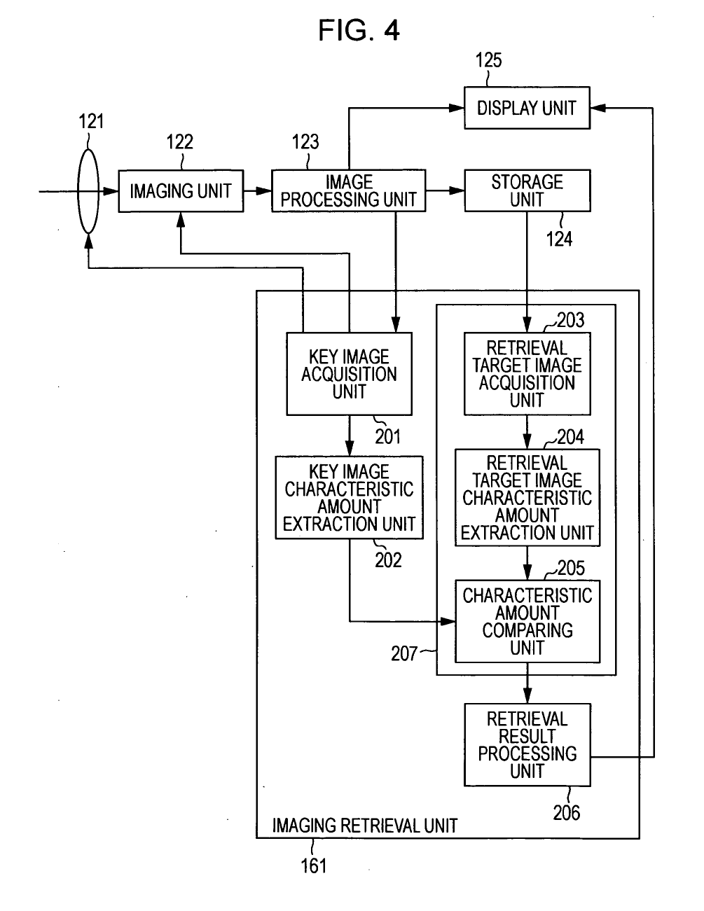

FIG. 4 is a block diagram illustrating an example of the main configuration of the imaging retrieval unit 161.

As illustrated in FIG. 4, the imaging retrieval unit 161 includes a key image acquisition unit 201, a key image characteristic amount extraction unit 202, a retrieval target image acquisition unit 203, a retrieval target image characteristic amount extraction unit 204, a characteristic amount comparing unit 205, and a retrieval result processing unit 206. The arrows in FIG. 4 indicate the main information-transfer directions or the control relationships. Each block is able to transmit/receive signals (data) to/from any of the other blocks, as necessary, in directions other than the directions illustrated in FIG. 4.

The key image acquisition unit 201 drives the optical unit 121, the imaging unit 122, and the image processing unit 123 so as to perform imaging and generate image data of acquired images. The key image acquisition unit 201 acquires the image data of the acquired images from the image processing unit 123. The key image acquisition unit 201 uses images of the acquired image data as key images used for retrieval and supplies the image data to the key image characteristic amount extraction unit 202.

The key image characteristic amount extraction unit 202 extracts a predetermined characteristic amount from the images (key images) of the image data supplied from the key image acquisition unit 201. Here, the characteristic amount may be any information as long as it is about images. For example, the characteristic amount may be an amount or value of a histogram of RGB or YCbCr and may be an amount or value of an image analysis result such as the result of face recognition. The characteristic amount of the key image may be composed of one kind of information and may include a plurality of kinds of information. For example, in addition to the above-mentioned characteristic amount of images, the characteristic amount of key images may include an amount or value of various shooting conditions such as, for example, shooting date, shooting location, exposure, and focal distance. Furthermore, the characteristic amount of key images may include information on a file (image data) itself such as a file size, for example. The key image characteristic amount extraction unit 202 extracts the entirety of information (characteristic amount, shooting condition, and the like) used as the characteristic amount of key images and supplies them to the characteristic amount comparing unit 205.

The retrieval target image acquisition unit 203 acquires image data from the storage unit 124 as image data of an image (retrieval target image) that is to be retrieved and supplies the image data to the retrieval target image characteristic amount extraction unit 204.

The retrieval target image characteristic amount extraction unit 204 extracts a predetermined characteristic amount from the image (retrieval target image) of the image data supplied from the retrieval target image acquisition unit 203. This characteristic amount may be any information as long as it is identical to the characteristic amount of the key images extracted by the key image characteristic amount extraction unit 202. That is to say, when the characteristic amount of key images includes a plurality of kinds of information, the characteristic amount of the retrieval target images includes the plurality of kinds of information. The retrieval target image characteristic amount extraction unit 204 supplies the extracted characteristic amount to the characteristic amount comparing unit 205.

The characteristic amount comparing unit 205 compares the characteristic amount of the key image supplied from the key image characteristic amount extraction unit 202 with the characteristic amount of the retrieval target image supplied from the retrieval target image characteristic amount extraction unit 204 to determine whether or not the characteristic amount of the key image is identical or similar to the characteristic amount of the retrieval target image. When the characteristic amount includes a plurality of kinds of information, parts or the entirety of the kinds of the information are compared with each other as necessary. The characteristic amount comparing unit 205 supplies the determination results to the retrieval result processing unit 206. When the characteristic amount of the key image is determined to be identical or similar to the characteristic amount of the retrieval target image, the characteristic amount comparing unit 205 uses the retrieval target images as images corresponding to the key image and supplies the image data of the retrieval target images to the retrieval result processing unit 206.

The retrieval target image acquisition unit 203 and the retrieval target image characteristic amount extraction unit 204 acquires an entirety of the image data stored in the storage unit 124 as the retrieval target images and extracts the characteristic amount of each image. When the retrieval target is limited to a part of the image data stored in the storage unit 124, or the number of retrieval target images is limited to a predetermined number, the retrieval target image acquisition unit 203 and the retrieval target image characteristic amount extraction unit 204 acquires an entirety of image data used as the retrieval target under such limitation (that is, a part of the image data stored in the storage unit 124) as the retrieval target images. That is to say, the characteristic amount comparing unit 205 performs the comparing of the characteristic amount with respect to the entirety of retrieval target images.

The retrieval result processing unit 206 performs processing on the results of the retrieval performed in the described manner. For example, the retrieval result processing unit 206 displays a list of thumbnail images of the image data supplied from the characteristic amount comparing unit 205 on the display unit 125 as the retrieval results.

The retrieval target image acquisition unit 203, the retrieval target image characteristic amount extraction unit 204, and the characteristic amount comparing unit 205 will be collectively referred to as a retrieval unit 207. That is to say, the retrieval unit 207 retrieves a desired image from the images of the image data stored in the storage unit 124 using the characteristic amount of the key image.

### Exemplary Configuration of Selective Retrieval Unit

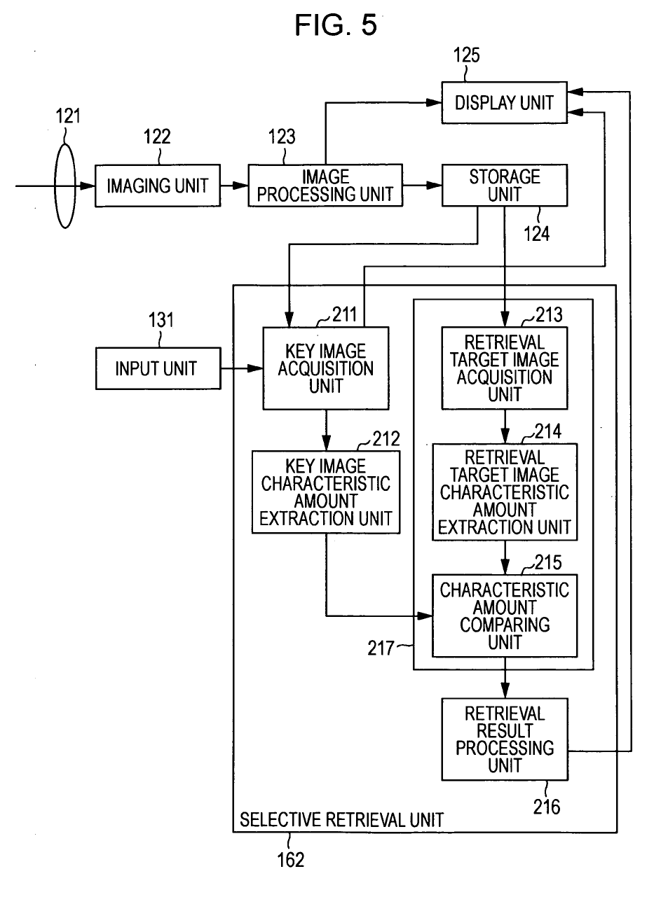

FIG. 5 is a block diagram illustrating an example of the main configuration of the selective retrieval unit 162.

As illustrated in FIG. 5, the selective retrieval unit 162 includes a key image acquisition unit 211, a key image characteristic amount extraction unit 212, a retrieval target image acquisition unit 213, a retrieval target image characteristic amount extraction unit 214, a characteristic amount comparing unit 215, and a retrieval result processing unit 216. The arrows in FIG. 5 indicate the main information-transfer directions or the control relationships. Each block is able to transmit/receive signals (data) to/from any of the other blocks, as necessary, in directions other than the directions illustrated in FIG. 5.

The key image acquisition unit 211 acquires image data that are selected by the user from the image data stored in the storage unit 124. The key image acquisition unit 211 uses images of the acquired image data as key images used for retrieval and supplies the image data to the key image characteristic amount extraction unit 212.

The key image characteristic amount extraction unit 212 extracts a predetermined characteristic amount from the images (key images) of the image data supplied from the key image acquisition unit 211. Here, the characteristic amount may be any information as long as it is about images, similar to the case of the imaging retrieval unit 161. The key image characteristic amount extraction unit 212 supplies the extracted characteristic amount to the characteristic amount comparing unit 215.

The retrieval target image acquisition unit 213 acquires image data (which are different from the image data of the key image) from the storage unit 124 as image data of an image (retrieval target image) that is to be retrieved and supplies the image data to the retrieval target image characteristic amount extraction unit 214.

The retrieval target image characteristic amount extraction unit 214 extracts a predetermined characteristic amount from the image (retrieval target image) of the image data supplied from the retrieval target image acquisition unit 213. This characteristic amount may be any information as long as it is identical to the characteristic amount of the key images extracted by the key image characteristic amount extraction unit 212. The retrieval target image characteristic amount extraction unit 214 supplies the extracted characteristic amount to the characteristic amount comparing unit 215.

The characteristic amount comparing unit 215 compares the characteristic amount of the key image supplied from the key image characteristic amount extraction unit 212 with the characteristic amount of the retrieval target image supplied from the retrieval target image characteristic amount extraction unit 214 to determine whether or not the characteristic amount of the key image is identical or similar to the characteristic amount of the retrieval target image. The characteristic amount comparing unit 215 supplies the determination results to the retrieval result processing unit 216. When the characteristic amount of the key image is determined to be identical or similar to the characteristic amount of the retrieval target image, the characteristic amount comparing unit 215 uses the retrieval target images as images corresponding to the key image and supplies the image data of the retrieval target images to the retrieval result processing unit 216.

The retrieval target image acquisition unit 213 and the retrieval target image characteristic amount extraction unit 214 acquire an entirety of the image data stored in the storage unit 124 as the retrieval target images and extracts the characteristic amount of each image. When the retrieval target is limited to a part of the image data stored in the storage unit 124, or the number of retrieval target images is limited to a predetermined number, the retrieval target image acquisition unit 213 and the retrieval target image characteristic amount extraction unit 214 acquires an entirety of image data used as the retrieval target under such limitation (that is, a part of the image data stored in the storage unit 124) as the retrieval target images. That is to say, the characteristic amount comparing unit 215 performs the comparing of the characteristic amount with respect to the entirety of retrieval target images.

The retrieval result processing unit 216 performs processing on the results of the retrieval performed in the described manner. For example, the retrieval result processing unit 216 displays a list of thumbnail images of the image data supplied from the characteristic amount comparing unit 215 on the display unit 125 as the retrieval results.

The retrieval target image acquisition unit 213, the retrieval target image characteristic amount extraction unit 214, and the characteristic amount comparing unit 215 will be collectively referred to as a retrieval unit 217. That is to say, the retrieval unit 217 retrieves a desired image from the images of the image data stored in the storage unit 124 using the characteristic amount of the key image.

Process Flow

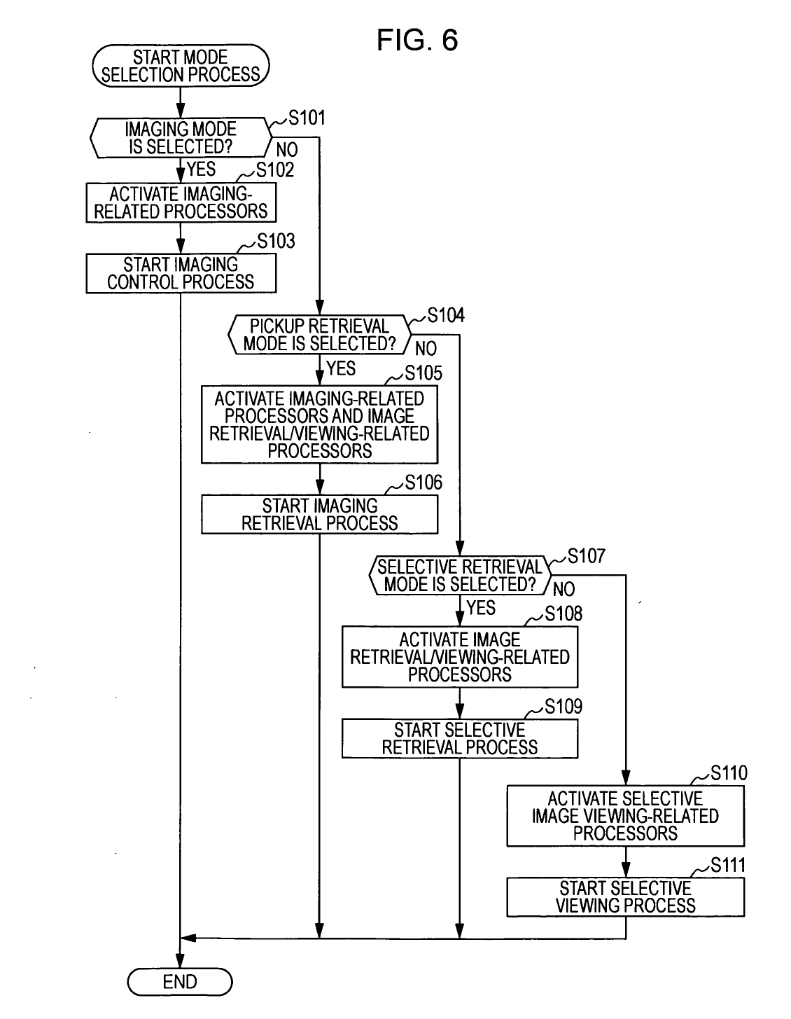

Next, an example of the flow of the processes executed by the control unit 111 will be described. First, a mode selection process will be described with reference to the flowchart of FIG. 6.

When an operation mode change command is input by the user operating an input unit (e.g., a switch), for example, the control unit 111 starts a mode selection process.

When the mode selection process is started, the mode selection unit 151 of the control unit 111 determines at step S101 whether or not an imaging mode is selected by a change command input by the user. When it is determined that the imaging mode is selected, the process flow proceeds to step S102. When the imaging mode is selected, the imaging control unit 152 activates, at step S102, imaging-related processors such as, for example, the units 121 to 125 (the optical unit 121 to the display unit 125) and controls the activated processors to start an imaging control process of imaging a subject at step S103. When the imaging control process is started, the mode selection unit 151 terminates the mode selection process.

When it is determined at step S101 that the imaging mode is not selected, the process flow proceeds to step S104. At step S104, the mode selection unit 151 determines whether or not a pickup retrieval mode is selected. When it is determined that the pickup retrieval mode is selected, the process flow proceeds to step S105. When the pickup retrieval mode is selected, the imaging retrieval unit 161 activates, at step S105, imaging-related processors and image retrieval/viewing-related processors such as, for example, the units 121 to 124 (the optical unit 121 to the storage unit 124). At step S106, the imaging retrieval unit 161 controls the activated processors to start an imaging retrieval process of imaging a subject and performing image retrieval using the acquired image as a key image. When the imaging retrieval process is started, the mode selection unit 151 terminates the mode selection process.

When it is determined at step S104 that the pickup retrieval mode is not selected, the process flow proceeds to step S107. At step S107, the mode selection unit 151 determines whether or not a selective retrieval mode is selected. When it is determined that the selective retrieval mode is selected, the process flow proceeds to step S108. When the selective retrieval mode is selected, the selective retrieval unit 162 activates, at step S108, image retrieval/viewing-related processors such as, for example, the units 123 to 125 (the image processing unit 123 to the display unit 125). At step S109, the selective retrieval unit 162 controls the activated processors to start a selective retrieval process of performing image retrieval using an image selected by the user as a key image. When the selective retrieval process is started, the mode selection unit 151 terminates the mode selection process.

When it is determined at step S107 that the selective retrieval mode is not selected, the process flow proceeds to step S110 while determining that a selective viewing mode is selected. When the selective viewing mode is selected, the selective viewing unit 163 activates, at step S110, selective image viewing-related processors such as, for example, the units 123 to 125 (the image processing unit 123 to the display unit 125). At step S111, the selective viewing unit 163 starts a selective viewing process of displaying images selected by the user. When the selective viewing process is started, the mode selection unit 151 terminates the mode selection process.

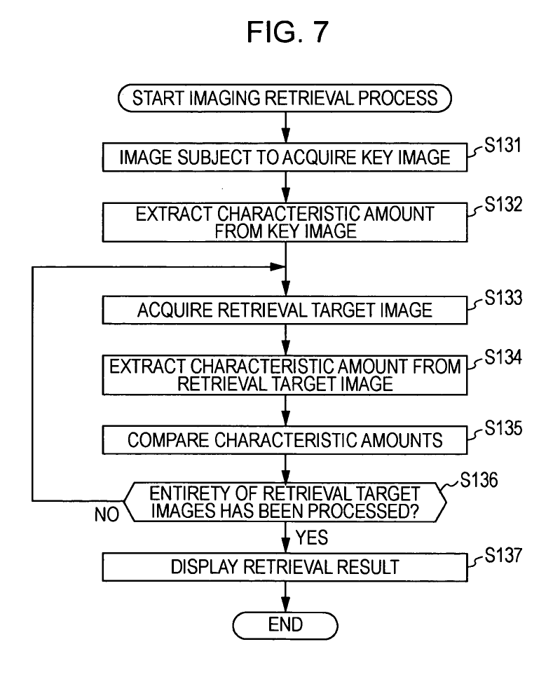

Next, the imaging retrieval process executed by the imaging retrieval unit 161 will be described with reference to the flowchart of FIG. 7. For example, when the imaging retrieval process is started by the execution of the process of step S106 in FIG. 6, the key image acquisition unit 201 images a subject to acquire a key image at step S131.

At step S132, the key image characteristic amount extraction unit 202 extracts a predetermined characteristic amount from the key image. At step S133, the retrieval target image acquisition unit 203 acquires image data of images used as the retrieval target images from the storage unit 124. At step S134, the retrieval target image characteristic amount extraction unit 204 extracts a characteristic amount from the retrieval target images acquired at step S133.

At step S135, the characteristic amount comparing unit 205 compares the characteristic amount of the key image extracted at step S132 with the characteristic amount of the retrieval target image extracted at step S134. At step S136, the characteristic amount comparing unit 205 determines whether or not the entirety of the retrieval target images has been processed. When it is determined that there is any image which has not been processed among the retrieval target images, the process flow returns to step S133, and the subsequent processes are performed. That is to say, the processes of steps S133 to S136 are repeatedly executed until the entirety of the retrieval target images are processed.

When it is determined at step S136 that the entirety of the retrieval target images has been processed, the process flow proceeds to step S137. At step S137, the retrieval result processing unit 206 displays retrieval target images of which the characteristic amounts are identical or similar to the characteristic amount of the key image based on the result of the characteristic amount comparison or a list thereof on the display unit 125. When the process of step S137 ends, the imaging retrieval unit 161 terminates the imaging retrieval process.

The imaging retrieval unit 161 may repeatedly execute the imaging retrieval process during the pickup retrieval mode.

As described above, since the imaging apparatus 100 performs image retrieval using images (the characteristic amount thereof) as the retrieval key, users are able to retrieve a desired image easily. For example, in the selective viewing mode, the imaging apparatus 100 presents a list of thumbnail images of the image data stored in the storage unit 124 to the user so as to allow the user to select a desired image from the list. However, the user's workload may increase as the number of images in the list increases. For example, it may be difficult with this method to find a desired image from several hundreds or thousands of images.

Therefore, when the imaging apparatus 100 performs image retrieval using a retrieval key so as to allow users to specify a desired image or narrow down images to be presented to the users, it is possible to decrease the user's workload on the image retrieval. Although there may be many things used as the retrieval key, since the retrieval target is an image, it may be difficult to perform retrieval using a character string as the retrieval key.

First of all, for the character string to be used as the retrieval key, it is necessary to register a character string to be used for the retrieval key in advance for each image. Moreover, even when the character string is registered for each image, it is not easy to express properly the characteristics of an image as words, for example. In addition, the words may not be said to be identical to the user's impression on the image. Therefore, it is difficult to register a character string which is effective as the retrieval key for each image. Furthermore, although a method in which a user designates information on an image such as shooting date or shooting condition as the retrieval key may be considered, in that case, the user has to have the correct understanding of each image.

Furthermore, since it is not desirable to make the casing of the imaging apparatus 100 unnecessarily large from the portability perspective, in many cases, it is difficult to mount an input device with high character input capability such as a keyboard for personal computers on the imaging apparatus 100. That is to say, it is difficult for users to input characters with the imaging apparatus 100.

On the contrary, since the imaging apparatus 100 performs image retrieval using images (characteristic amount thereof) as the retrieval key, users are easily able to retrieve a desired image by just setting an image which is visually similar to the desired image as the retrieval key.

In other words, it may not be said that the users have the correct understanding of the details of a desired image. When a character string is used as the retrieval key, there is a concern that a small misunderstanding leads to a critical error. For example, when a desired image is an image of “a red car”, if a user misremembers that image as an image of “a subway car”, the user may set “subway car” as the retrieval key; however, it may not be possible to find an image of “a red car” with that retrieval key (subway car).

On the contrary, in the case of using images (characteristic amount thereof) as the retrieval key, even if the user sets an image of a subway car as the retrieval key, when the configuration of that image (image of the subway car) is similar to the configuration of the desired image (image of the red car), there is a possibility that these images have similar characteristic amounts, and the desired image is retrieved.

As described above, when images are used as the retrieval key, it is possible to increase the possibility that the desired image is properly retrieved even when the user has a confused memory.

The imaging apparatus 100 has a function for imaging a subject, such as, for example, the optical unit 121 and the imaging unit 122. The imaging retrieval unit 161 generates an image to be used as the retrieval key (key image) by using this imaging function. For example, when an image is displayed on the display unit 125, the user searches for a subject from the surroundings and determines a composition or the like so as to obtain an image of which the characteristic amount is identical or similar to the characteristic amount of that image, and then performs imaging of the key image. In this way, the user is easily and freely able to set the key image by just imaging a subject using the imaging apparatus 100.

Furthermore, since the imaging apparatus 100 is an apparatus for imaging a subject, the surface of the casing, the operation method, and the like are configured so that the imaging operation is performed easily. Therefore, users are able to image an arbitrary subject from an arbitrary angle and with an arbitrary imaging condition more easily. That is to say, the users are more easily and freely able to set the key image.

Furthermore, the images used as the retrieval target images are images which have been imaged in the past by the imaging apparatus 100 and stored in the storage unit 124. That is to say, the user is able to obtain the image to be used as the key image by using the same configuration (e.g., the units 121 to 123 (the optical unit 121 to the image processing unit 123)) as that used for generating the retrieval target images. Therefore, the user is easily able to obtain the key image of which the characteristic amount is similar to that of the retrieval target images.

For example, in the case of obtaining the key image with a different configuration from that used for generating the retrieval target images, even when a user assimilates the characteristics of the key image to those of the retrieval target images, it may be difficult to make them entirely similar due to a difference in configuration. Furthermore, a case may occur where they are unintentionally made similar. However, as described above, when the key image is generated using the same configuration as that used for generating the retrieval target images, the user is able to make the imaging conditions of the key image and the like identical, or not identical, to those of the retrieval target images depending on the user's intention. That is to say, the retrieval is made easier.

Furthermore, since the imaging apparatus 100 performs the imaging retrieval not in the imaging mode but in the viewer mode while omitting the imaging retrieval process during a normal imaging mode, it is possible to suppress an unnecessary increase in power consumption. The imaging retrieval may be performed during the imaging mode, if necessary. However, by providing a pickup retrieval mode and controlling the imaging retrieval process in the pickup retrieval mode, the imaging apparatus 100 is able to perform the imaging retrieval with minimum necessary power consumption.

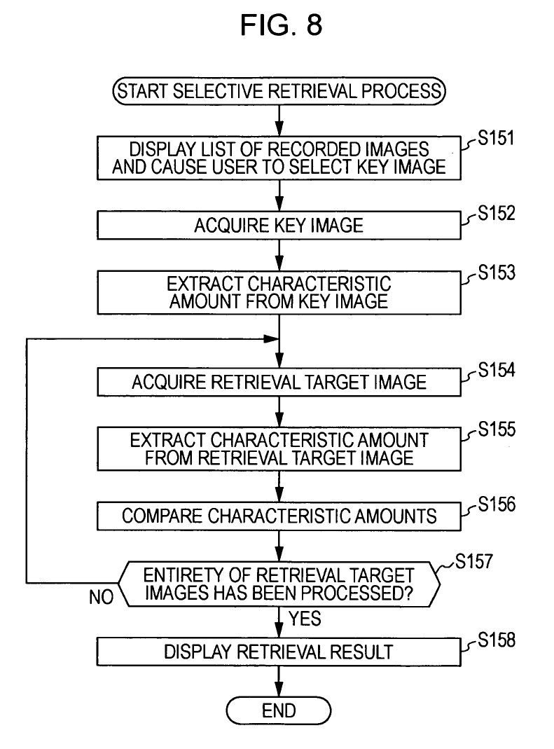

Next, the selective retrieval process executed by the selective retrieval unit 162 will be described with reference to the flowchart of FIG. 8. For example, when the imaging retrieval process is started by the execution of the process of step S109 in FIG. 6, the key image acquisition unit 211 displays a list of recorded images which are images of the image data stored in the storage unit 124 on the display unit 125 and allows a user to select a key image from the recorded images at step S151. At step S152, the key image acquisition unit 211 acquires image data of the image which is selected by the user as the key image by the process of step S151 from the storage unit 124.

The processes of steps S153 to S158 are respectively performed in the same manner as the processes of steps S132 to S137 in FIG. 7. That is to say, at step S153, the key image characteristic amount extraction unit 212 extracts a predetermined characteristic amount from the key image. At step S154, the retrieval target image acquisition unit 213 acquires image data of images used as the retrieval target images from the storage unit 124. At step S155, the retrieval target image characteristic amount extraction unit 214 extracts a characteristic amount from the retrieval target images acquired at step S154.

At step S156, the characteristic amount comparing unit 215 compares the characteristic amount of the key image extracted at step S153 with the characteristic amount of the retrieval target image extracted at step S155. At step S157, the characteristic amount comparing unit 215 determines whether or not the entirety of the retrieval target images has been processed. When it is determined that there is any image which has not been processed among the retrieval target images, the process flow returns to step S154, and the subsequent processes are performed.

When it is determined at step S157 that the entirety of the retrieval target images has been processed, the process flow proceeds to step S158. At step S158, the retrieval result processing unit 216 displays retrieval target images of which the characteristic amounts are identical or similar to the characteristic amount of the key image based on the result of the characteristic amount comparison or a list thereof on the display unit 125. When the process of step S158 ends, the selective retrieval unit 162 terminates the selective retrieval process.

The selective retrieval unit 162 may repeatedly execute the selective retrieval process during the selective retrieval mode.

As described above, in the selective retrieval mode, the user is able to select the key image from the images stored in the storage unit 124. By doing so, the user is able to perform the image retrieval without performing imaging. Due to this configuration, since it is not necessary to drive the optical unit 121, the imaging unit 122, and the like, the imaging apparatus 100 is able to reduce power consumption.

### Method of Displaying Retrieval Results

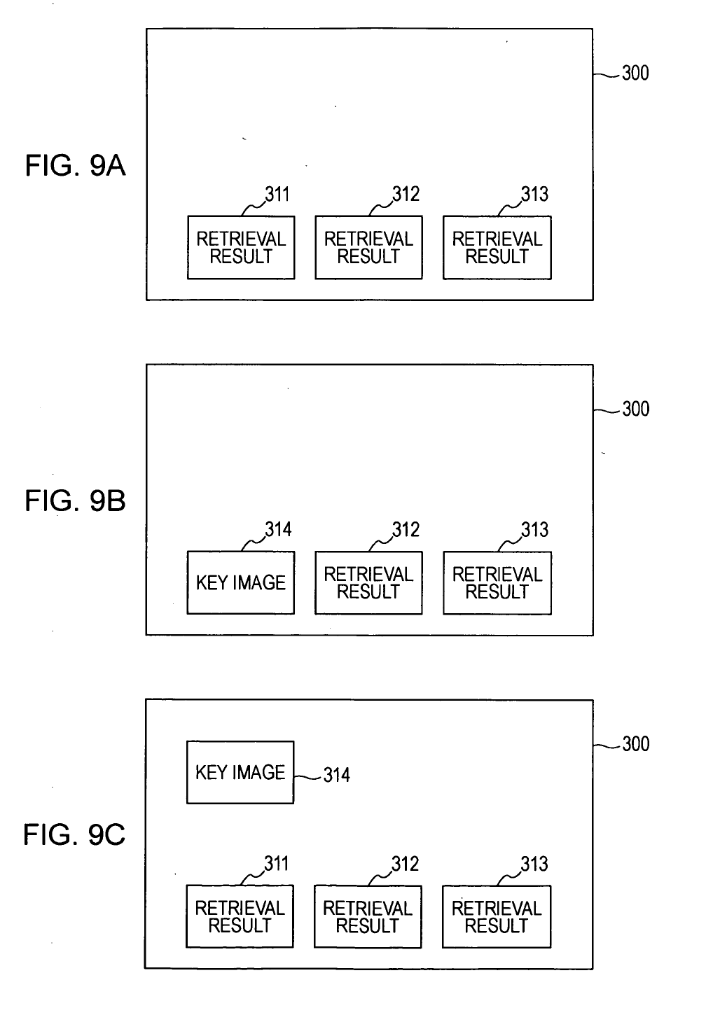

Next, an example of a method of displaying the retrieval results on the display unit 125 will be described with reference to FIGS. 9A to 9C to FIGS. 12A to 12C. A retrieval result screen 300 illustrated in FIGS. 9A to 9C to FIGS. 12A to 12C is a screen which is displayed on the display unit 125 so as to display the retrieval results of the above-described image retrieval (imaging retrieval or selective retrieval).

As illustrated in FIG. 9A, images (retrieval result images) which are determined to be identical or similar to the key image, for example, are displayed on the retrieval result screen 300. In the example of FIG. 9A, images 311 to 313 are the retrieval result images (reduced images thereof (thumbnail images thereof)). For example, when the user selects one of the retrieval result images (the thumbnail images thereof) being displayed, the selected image is displayed on the display unit 125 in an enlarged size. That is to say, when a list of retrieval result images is displayed on the retrieval result screen 300 and the user selects an image in the list, the selected image is displayed in a size larger than that in the list.

By displaying the retrieval results in this manner, the user is easily able to view the retrieval results.

It is preferable from the perspective of improvement in the image quality that the resolution of the image which is selected by the user to be displayed is higher than the resolution when the image is displayed as a list. However, from the perspective of improvement in the processing speed, the resolution of the image which is selected by the user to be displayed may be the same as the resolution when the image is displayed as a list.

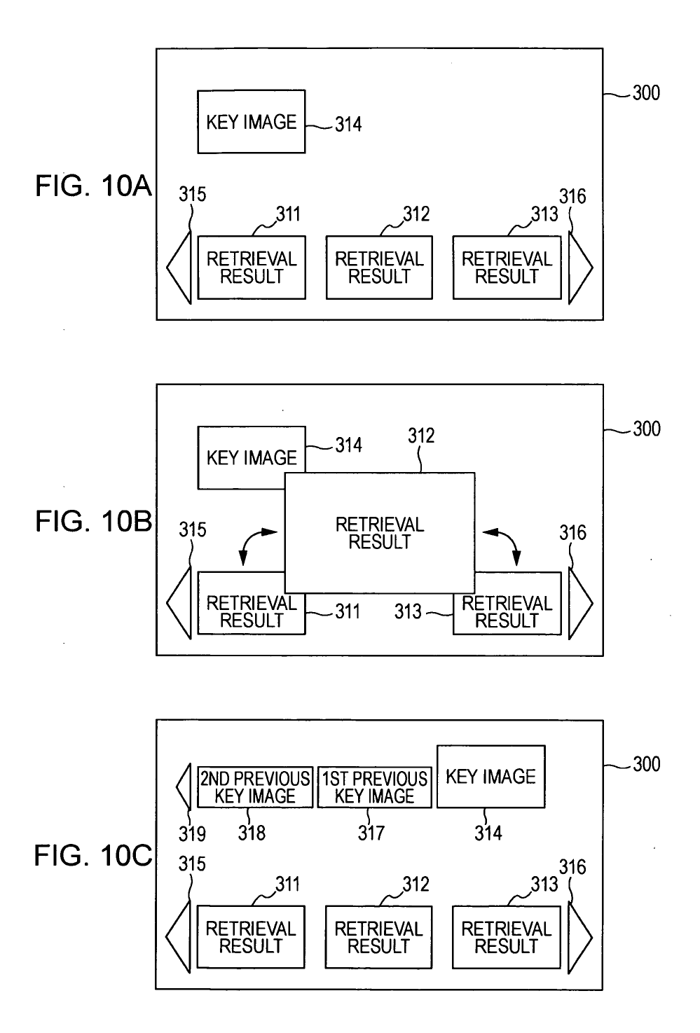

Although the characters “retrieval result” are depicted as the retrieval result images 311 to 313 in FIGS. 9A to 9C for convenience of explanation, each image is actually displayed. The same can be said for FIGS. 10A to 10C to FIGS. 12A to 12C. Moreover, the number of retrieval result images displayed on the retrieval result screen 300 is arbitrary. Furthermore, the resolution of the retrieval result images displayed on the retrieval result screen 300 is arbitrary. In the following description, description on the resolution will be omitted unless necessary.

Moreover, as illustrated in FIG. 9B, a key image may be displayed on the retrieval result screen 300 together with the retrieval result images, for example. In the example of FIG. 9B, the key image (reduced image thereof), specifically a key image 314 is displayed on the retrieval result screen 300 in lieu of the retrieval result image 311 of FIG. 9A.

Similar to the case of FIG. 9A, when the user selects any one of the retrieval result images 312 and 313 on the retrieval result screen 300, the selected image is displayed in an enlarged size.

By displaying the retrieval results in this manner, the user is easily able to view the key image together with the retrieval results and select images from the retrieval results while comparing them with the key image.

Furthermore, the resolution of the key image displayed on the retrieval result screen 300 is arbitrary similarly to the retrieval result images. In the following description, description of the resolution will be omitted unless necessary.

Furthermore, as illustrated in FIG. 9C, the key image may be displayed, for example, at a position of a row different from the row of the retrieval result images on the retrieval result screen 300. For example, as illustrated in the example of FIG. 9C, the key image 314 may be displayed above the retrieval result image 311 on the retrieval result screen 300. Similar to the case of FIG. 9A or 9B, when the user selects any one of the retrieval result images 311 to 313 on the retrieval result screen 300, the selected image is displayed in an enlarged size.

By displaying the retrieval results in this manner, the user is easily able to view the key image together with the retrieval results and select images from the retrieval results while comparing them with the key image.

Furthermore, a capture image (moving image) may be displayed as the key image 314 on the retrieval result screen 300, and the retrieval may be performed using a frame image of the captured image as the retrieval key image when a predetermined condition is satisfied. In this case, a part or an entirety of the retrieval result images 311 to 313 being displayed on the retrieval result screen 300 is updated at every retrieval, if necessary.

For example, when the user operates the imaging apparatus 100 to shoot (capture) the faces of a plurality of subjects one by one, images are retrieved whenever the face of the subject in the key image 314 (the face of the subject in the capture image) changes, and the retrieval results of the retrieval using the subject's face at that time as the key image are sequentially displayed on the retrieval result screen 300.

Furthermore, as illustrated in FIG. 10A, when it is not possible to display the entirety of the retrieval result images on the retrieval result screen 300, a scroll button may be provided. In the case of the example of FIG. 10A, on the retrieval result screen 300, in addition to the configuration of the example of FIG. 9C, a scroll button 315 is displayed to the left of the retrieval result image 311, and a scroll button 316 is displayed to the right of the retrieval result image 313.

The presence of the scroll buttons 315 and 316 indicates that there is a retrieval result image which is not displayed on the retrieval result screen 300. When the user presses (clicks) the scroll button 315, the retrieval result images are scrolled to the right, whereby the retrieval result image 313 disappears, the retrieval result image 311 is moved to the position of the retrieval result image 312 in FIG. 10A, and a new retrieval result image which is not displayed in FIG. 10A is displayed to the left of the retrieval result image 311 (that is, the position of the retrieval result image 311 in FIG. 10A). When the user presses (clicks) the scroll button 316, the retrieval result images are scrolled to the left, whereby the retrieval result image 311 disappears, the retrieval result image 313 is moved to the position of the retrieval result image 312 in FIG. 10A, and a new retrieval result image which is not displayed in FIG. 10A is displayed to the right of the retrieval result image 313 (that is, the position of the retrieval result image 313 in FIG. 10A).

The plurality of retrieval result images being displayed on the retrieval result screen 300 may be displayed in different sizes. For example, as illustrated in FIG. 10B, a retrieval result image displayed at the center may be displayed in a larger size than the retrieval result images on the left and right. The configuration of the retrieval result screen 300 illustrated in FIG. 10B is basically the same as the configuration of the retrieval result screen 300 illustrated in FIG. 10A. In the case of the example of FIG. 10B, however, the retrieval result image 312 is displayed approximately at the center of the retrieval result screen 300 in a larger size than the retrieval result images 311 and 313. In addition, the retrieval result image 312 may be displayed so as to overlap the other images.

As illustrated in the example of FIG. 10A, the retrieval result image displayed in a larger size is changed when the user scrolls the retrieval result images. By doing so, the user is able to compare the retrieval result images more easily.

Furthermore, as illustrated in FIG. 10C, a plurality of key images may be displayed on the retrieval result screen 300. On the retrieval result screen 300 illustrated in FIG. 10C, a 1st previous key image 317, a 2nd previous key image 318, and a scroll button 319 are displayed together with a current key image 314. That is to say, in the case of the example of FIG. 10C, the key images on the retrieval result screen 300 are displayed in descending order of time from right to left. In this case, the older images (e.g., the 1st and 2nd previous key images) are stored in the storage unit 124, for example. The presence of the scroll button 319 indicates that there is a further older (3rd previous) key image. When the user clicks the scroll button 319, the key images are scrolled to the right, whereby the 2nd previous key image 318 is moved to the position of the 1st previous key image 317 in FIG. 10C, and a further older key image is displayed to the left of the 2nd previous key image 318 (that is, the position of the 2nd previous key image 318 in FIG. 10C).

When the user selects one of the plural key images being displayed in the described manner, the retrieval result images, corresponding to the selected key image are displayed on the retrieval result screen 300. By doing so, the user is able to browse the retrieval results for each key image and easily compare the retrieval results of each key image by selecting a different key image. Moreover, at this time the selected key image may be displayed in a larger size than the other key images. For example, in the case of FIG. 10C, the current key image 314 is selected by the user and is thus displayed in a larger size than the 1st previous key image 317 and the 2nd previous key image 318.

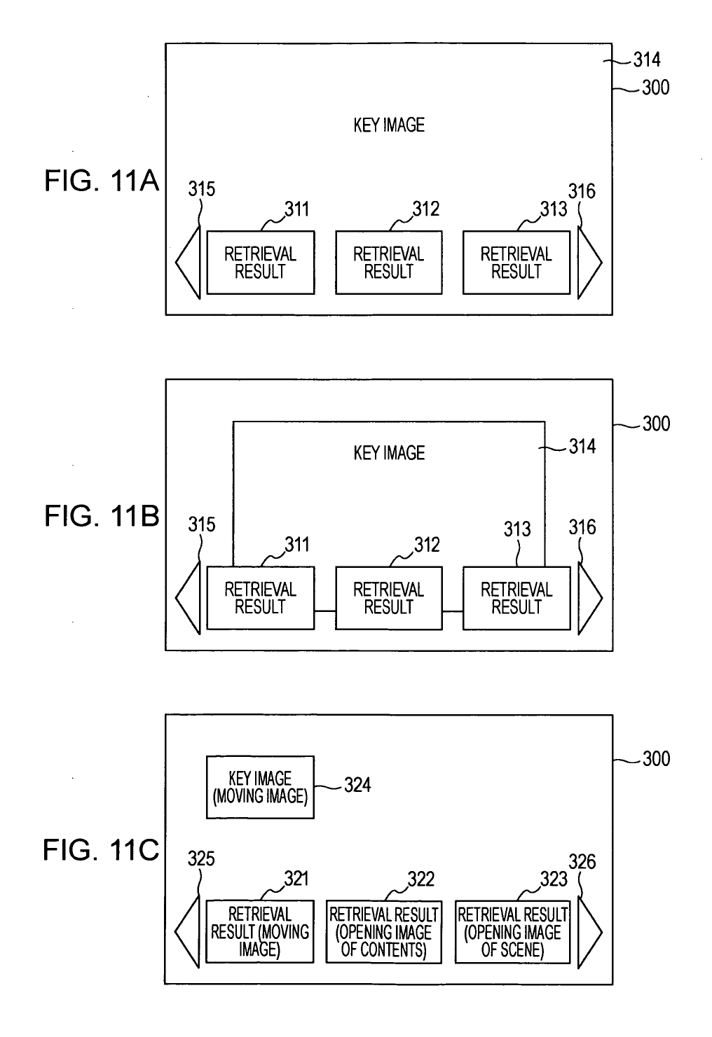

Furthermore, as illustrated in FIG. 11A, the key image 314 may be displayed on the whole screen of the retrieval result screen 300. In this case, the retrieval result images 311 to 313 and the scroll button 315 and 316 may be displayed so as to overlap the key image 314. By doing so, since the key image 314 is displayed in an enlarged size, the user is able to inspect the details of the key image 314 more easily.

Furthermore, as illustrated in FIG. 11B, even when the key image 314 is displayed in an enlarged size, it may be displayed in a portion of the retrieval result screen 300.

The key image or the retrieval target image may be a moving image. When the key image is a moving image, as illustrated in FIG. 11C, a moving image may be displayed as a key image 324 on the retrieval result screen 300.

When the retrieval target image is a moving image, as illustrated by a retrieval result image 321 in FIG. 11C, contents (moving image of the retrieval target image) of which the characteristic amount is determined to be identical or similar to the characteristic amount of the key image 324 may be displayed as a retrieval result on the retrieval result screen 300. Furthermore, as illustrated by a retrieval result image 322, an image (still image) of the beginning frame of contents of which the characteristic amount is determined to be identical or similar to the characteristic amount of the key image 324 may be displayed as a retrieval result on the retrieval result screen 300.

The image retrieval may be performed for each scene of the contents. In that case, as illustrated by a retrieval result image 323 in FIG. 11C, an image (still image) of the beginning frame of a scene of which the characteristic amount is determined to be identical or similar to the characteristic amount of the key image 324 may be displayed as a retrieval result on the retrieval result screen 300.

In addition, as illustrated by the retrieval result images 321 to 323 in FIG. 11C, a plurality of different kinds of images, such as a combination of a moving image and a still image, may be displayed as the retrieval results, and one kind of images (for example, only moving images) may be displayed as the retrieval results.

By doing so, the user is easily able to retrieve a desired image even when the retrieval result or the key image is a moving image.

The scroll buttons 325 and 326 correspond to the scroll buttons 315 and 316, respectively, which perform the same processes when operated by the user, whereby the retrieval result images are scrolled.

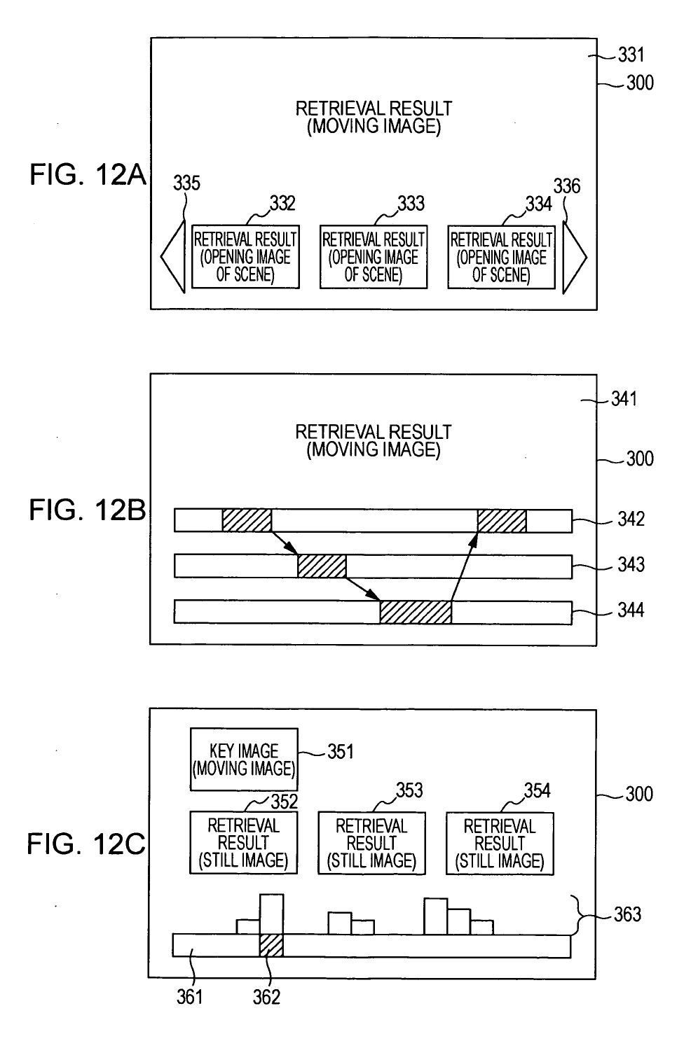

Furthermore, as illustrated in FIG. 12A, one retrieval result may be displayed in a plurality of methods. For example, in the case of FIG. 12A, a retrieval result image 331 which is a moving image is displayed on the whole screen of the retrieval result screen 300. In this case, the retrieval results are displayed so as to overlap the retrieval result image 331, and images (still images) of the beginning frames of the scenes constituting the moving image retrieved as the retrieval result are displayed as retrieval result images 332 to 334. The scroll buttons 335 and 336 correspond to the scroll buttons 315 and 316, respectively, which perform the same processes when operated by the user, whereby the retrieval result images (images of the beginning frames of each scene) are scrolled (that is, the displayed positions are changed).

In addition, the key image may be a frame image in a moving image which has been stored. For example, in this case, as illustrated in FIG. 12C, a moving image may be displayed as a key image 351 on the retrieval result screen 300, and retrieval may be performed when the frame images of the frame image satisfy a predetermined condition, so that retrieved images (still images) are displayed as the retrieval results (retrieval results 352 to 354). In this case, the retrieval results displayed on the retrieval result screen 300 are appropriately updated every retrieval.

When the frame image of a moving image is used as the key image, there is a concern that the user is unable to know the part (scene or time frame) of the moving image to which the key image belongs. Therefore, for example, as illustrated in FIG. 12C, a progress bar 361 of the key image may be displayed on the retrieval result screen 300 so as to indicate a current playback position 362. That is to say, in the case of FIG. 12C, the progress bar 361 represents the entire length of the moving image, and a frame image of the moving image indicated by the current playback position 362 is the key image, which is displayed as a key image 351 on the retrieval result screen 300. By doing so, the user is easily able to know the part of the moving image to which the frame image corresponding to the current key image 351 belongs.

Furthermore, as illustrated in FIG. 12C, the number (hit count) of images (retrieval results) which are determined to be identical or similar to the key image may be displayed as a bar graph 363 for each retrieval so as to be drawn on the progress bar 361 of the retrieval result screen 300 in the vicinity positions corresponding to the position of the key image. By doing so, the user is easily able to obtain information on the distribution of the hit counts.

The information on the hit count distribution may be prepared in advance. For example, the control unit 111 may perform a retrieval process in advance to obtain information on the hit count distribution and store the information in the storage unit 124. Moreover, the hit count distribution may be generated during the retrieval performed while the retrieval result screen 300 is displayed. In this case, the bar graph 363 of the portion for which the retrieval has been completed, for example, is displayed.

By displaying the retrieval results in the described manner, the user is able to inspect the further details of the contents retrieved as the retrieval result.

### Another Exemplary Configuration of Selective Retrieval Unit

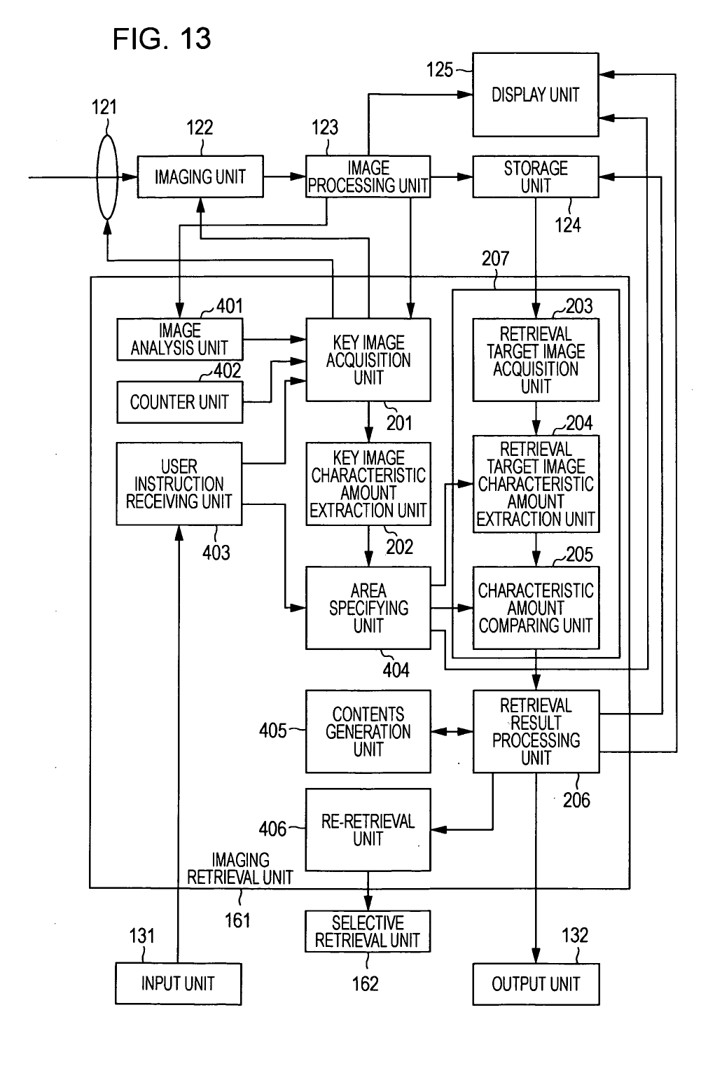

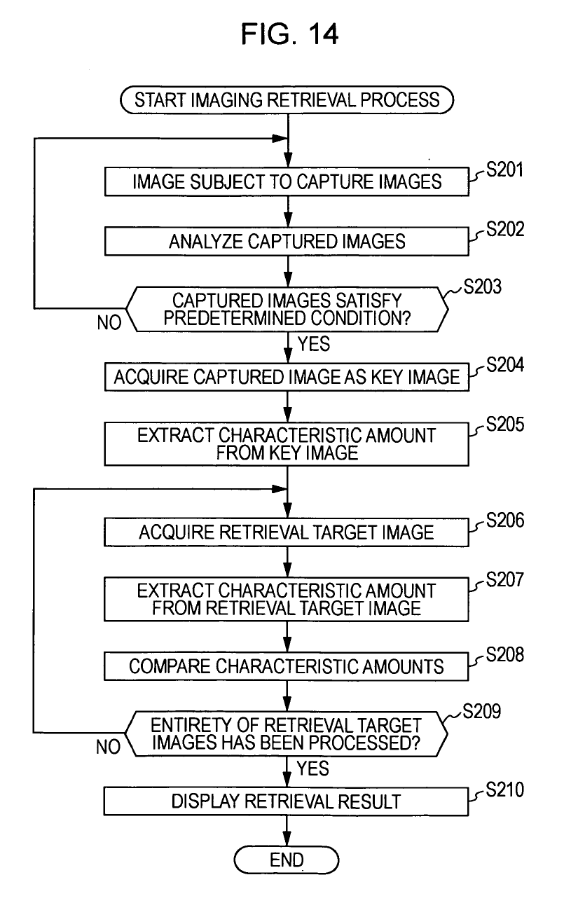

The imaging apparatus 100 may have a configuration other than the described one. FIG. 13 is a block diagram illustrating a modified example of the configuration of the imaging retrieval unit 161. The configuration will be described with reference to FIGS. 14 to 20.

The imaging retrieval unit 161 may analyze the contents of a captured image which is captured by the imaging unit 122 and acquire a key image based on the analysis results on the capture image. In this case, the imaging retrieval unit 161 further includes an image analysis unit 401 in addition to the configuration illustrated in FIG. 4.

The image analysis unit 401 controls the units 121 to 123 (the optical unit 121 to the image processing unit 123) so as to acquire a captured image which is captured by the imaging unit 122 from the image processing unit 123 and performs image analysis such as smile detection on the captured image. The image analysis unit 401 supplies the analysis results to the key image acquisition unit 201. The key image acquisition unit 201 then acquires a key image by referring to the supplied analysis results when a predetermined condition is satisfied (for example, when a smile is detected). This condition is set arbitrarily and may be any condition.

An example of the flow of the imaging retrieval process applicable to that case will be described with reference to the flowchart of FIG. 14. This flowchart corresponds to the flowchart of FIG. 7.

When the imaging retrieval process is started, the image analysis unit 401 images a subject to capture an image at step S201. At step S202, the image analysis unit 401 analyzes the captured image. At step S203, the key image acquisition unit 201 determines whether or not the captured image satisfies a predetermined condition based on the analysis results of step S202. When it is determined that the predetermined condition is not satisfied, the process flow returns to step S201, and subsequent processes are performed. When it is determined at step S203 that the predetermined condition is satisfied, the process flow proceeds to step S204.

The processes of steps S204 to S210 are respectively performed in the same manner as the processes of steps S131 to S137 in FIG. 7.

By doing so, the key images are acquired (updated) only when a smile or a scene change is detected in the captured image, for example. Therefore, it is possible to suppress acquisition of an unnecessary key image and an increase in processing load.

The imaging retrieval unit 161 may acquire the key images at a predetermined timing such as, for example, every predetermined period of time, every predetermined number of frames, and every predetermined times. In this case, the imaging retrieval unit 161 further includes a counter unit 402 in addition to the configuration illustrated in FIG. 4.

The counter unit 402 monitors the time, measures a period of time, or counts the number of frames to determine whether or not predetermined timing occurs, for example, by determining whether or not it is a predetermined time; a predetermined period of time has passed; or a predetermined number of frames has been processed, and, when the predetermined timing occurs, sends a notification to the key image acquisition unit 201, informing that the predetermined timing has occurred. The key image acquisition unit 201 acquires a key image in response to the notification. That is to say, the key image acquisition unit 201 acquires a key image at the predetermined timing.

In addition, the imaging retrieval unit 161 may acquire the key images in response to a user's instruction, for example. In this case, the imaging retrieval unit 161 further includes a user instruction receiving unit 403 in addition to the configuration illustrated in FIG. 4.

The user instruction receiving unit 403 receives a user's instruction instructing to acquire key images, such as pressing of a release button, which is input to the input unit 131 by the user or the like and supplies the received user's instruction to the key image acquisition unit 201. The key image acquisition unit 201 acquires key images in response to the user's instruction. Here, the method of inputting the user's instruction instructing to acquire key images is arbitrary and may be based on any operation.

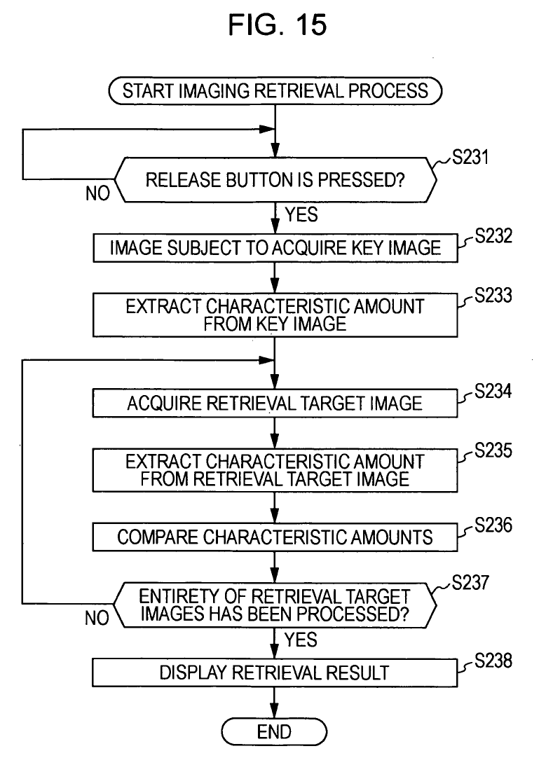

An example of the flow of the imaging retrieval process applicable to this case will be described with reference to the flowchart of FIG. 15. This flowchart corresponds to the flowchart of FIG. 7.

When the imaging retrieval process is started, the user instruction receiving unit 403 determines at step S231 whether or not a release button is pressed (an operation instructing to acquire key images is input) and waits until it is determined that the release button is pressed. When it is determined at step S231 that the release button is pressed (the operation instructing to acquire key images is input), the process flow proceeds to step S232.

The processes of steps S232 to S238 are respectively performed in the same manner as the processes of steps S131 to S137 in FIG. 7.

By doing so, the user is able to instruct acquisition of key images. Therefore, the user is easily able to obtain a desired key image. Moreover, since it is possible to suppress acquisition of an unnecessary key image, the imaging apparatus 100 is able to suppress an increase in processing load.

The process flow of the case where the key image acquisition unit 201 acquires a key image based on the counting results of the counter unit 402 is basically the same as the flowchart of FIG. 15. However, in the process of step S231, the counter unit 402 determines whether or not the predetermined timing occurs and waits until the predetermined timing has occurred. When it is determined that the predetermined timing has occurred, the process flow proceeds to step S232.

Moreover, the imaging retrieval unit 161 may be configured to include at least two of the units 401 to 403 (the image analysis unit 401 to the user instruction receiving unit 403). In that case, the acquisition of key images is performed based on a plurality of conditions.

Furthermore, the acquisition of key images may be performed based on occurrence of an event other than the described ones.

In addition, the imaging retrieval unit 161 performs the comparing of characteristic amounts between the key image and the retrieval target image with respect to a partial area of an image. In this case, the imaging retrieval unit 161 further includes an area specifying unit 404 in addition to the configuration illustrated in FIG. 4.

The area specifying unit 404 specifies an area (target partial area) for which the characteristic amounts are compared based on the characteristic amounts extracted by the key image characteristic amount extraction unit 202, for example. For example, the area specifying unit 404 specifies the face portion of a figure included in the key image as a target partial area. The characteristic amount comparing unit 205 compares the characteristic amounts with respect to the specified target partial area.

Moreover, the area specifying unit 404 may specify the target partial area based on a user's instruction. For example, when the user operates the input unit 131 to input a user's instruction designating a range of a target partial area, the user instruction receiving unit 403 receives the user's instruction and sends a notification thereof to the area specifying unit 404. Upon receiving the notification from the user instruction receiving unit 403, the area specifying unit 404 specifies the target partial area in accordance with the user's instruction. The characteristic amount comparing unit 205 compares the characteristic amounts with respect to the specified target partial area.

Furthermore, the target partial area may be specified based on both the characteristics of a key image and the user's instruction, for example. For example, the area specifying unit 404 narrows down the candidates (target partial area candidates) for the target partial area based on the characteristic amount extracted by the key image characteristic amount extraction unit 202 and notifies the user of the target partial area candidates by controlling the display unit 125. Then, the user operates the input unit 131 to input a user's instruction by selecting a target partial area from the target partial area candidates. Upon receiving the user's instruction, the user instruction receiving unit 403 sends a notification thereof to the area specifying unit 404. Upon receiving the notification from the user instruction receiving unit 403, the area specifying unit 404 specifies the target partial area in accordance with the user's instruction. The characteristic amount comparing unit 205 compares the characteristic amounts with respect to the specified target partial area.

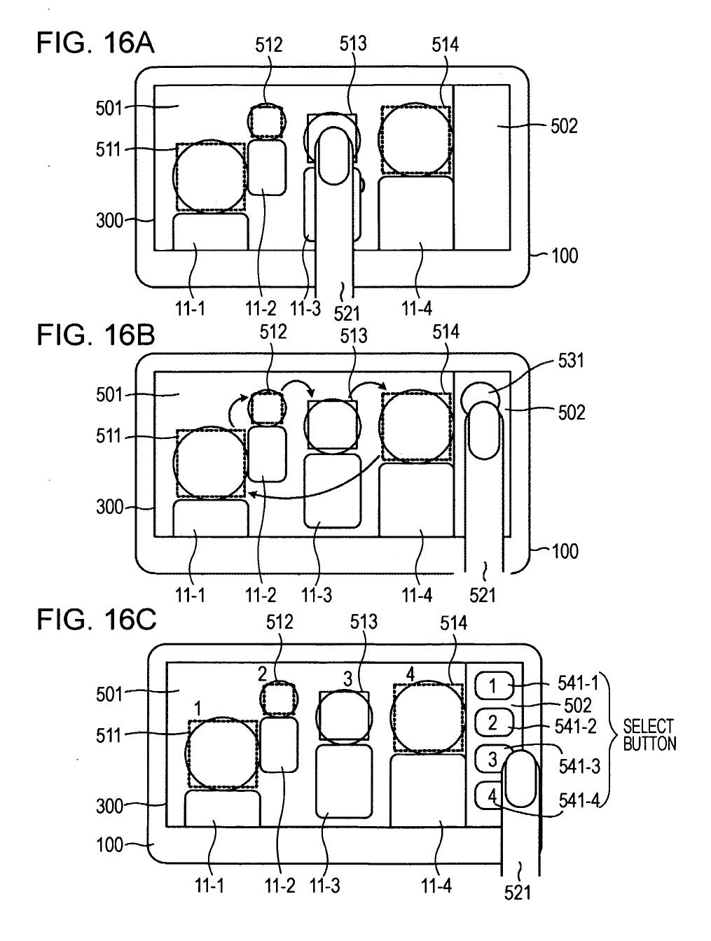

FIGS. 16A to 16C are schematic diagrams illustrating a method of specifying areas. In this example, a case will be described where the area specifying unit 404 specifies the face portion of a subject as a target partial area.

In the case of the example of FIG. 16A, the retrieval result screen 300 displayed on the display unit 125 of the imaging apparatus 100 includes a key image 501 and an operation area 502 in which a GUI for receiving a user's instruction is displayed. The key image 501 contains four subjects (subjects 11-1 to 11-4). In the case of the example of FIG. 16A, the area specifying unit 404 sets the face portions of each subject as target partial area candidates so that frames 511 to 514 defining the ranges of each target partial area candidate are displayed so as to overlap the key image 501. On the display surface of the display unit 125, a touch panel is embedded as the input unit 131, and the user selects a target partial area by designating the frame being displayed with a finger or the like.

For example, in the case of FIG. 16A, the user selecting the face portion of the subject 11-3 as the target partial area taps on the frame 513 on the touch panel embedded in the display unit 125 with a finger 521. The representation of the frame 513 being tapped is changed so as to indicate that it is being selected; for example, as illustrated in FIG. 16A, the frame 513 being selected by the user is drawn with a solid line while other frames are drawn with a dotted line.

In the case of the example of FIG. 16B, a change-over button 531 is displayed in the operation area 502 so that when the change-over button 531 is operated by the user, the frame selected as the target partial area is changed. For example, when the user operates (presses) the change-over button 531 with the finger 521, the frame selected as the target partial area in the key image 501 is changed as indicated by the arrows.

In the case of the example of FIG. 16C, select buttons 541-1 to 541-4 are displayed in the operation area 502 so that when one of the select buttons is operated by the user, a frame corresponding to the select button, which will be selected as the target partial area, is designated. For example, when the user selects the select button 541-3 with the finger 521, the frame 513 corresponding to the select button 541-3 is selected as the target partial area.

The method of receiving the user's instruction may be any method other than the described ones.

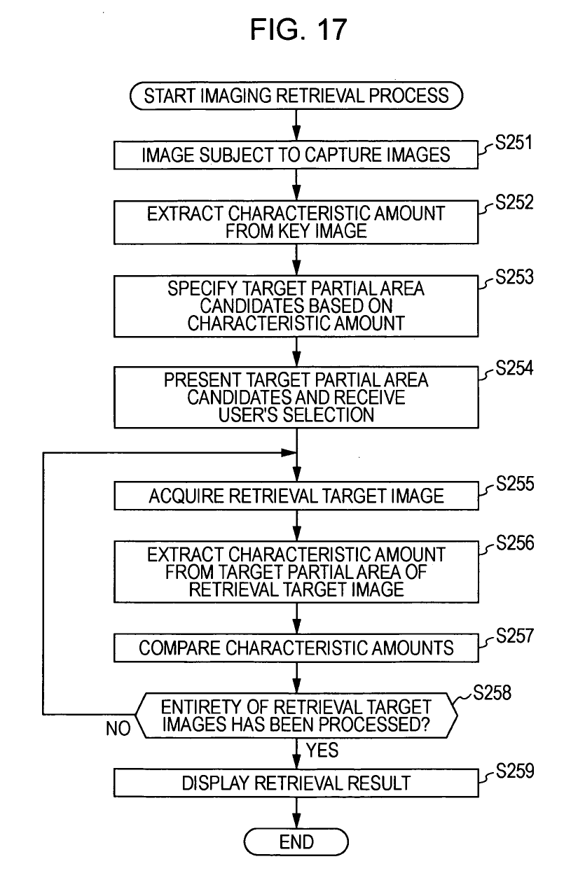

Next, an example of the flow of the imaging retrieval process will be described with reference to the flowchart of FIG. 17. This flowchart corresponds to the flowchart of FIG. 7. The processes of steps S251 and S252 are respectively performed in the same manner as the processes of steps S131 and S132 in FIG. 7.

When the characteristic amount is extracted, the area specifying unit 404 specifies target partial area candidates from a key image based on the characteristic amount of the key image at step S253. At step S254, the area specifying unit 404 presents the target partial area candidates to the user, and the user instruction receiving unit 403 receives the user's selection on the presentation. The area specifying unit 404 specifies the tap based on the user's selection.

At step S255, the retrieval target image acquisition unit 203 acquires retrieval target images in the same manner as the case of step S133 of FIG. 7. At step S256, the retrieval target image characteristic amount extraction unit 204 extracts a characteristic amount of the retrieval target images in the same manner as the case of step S134 of FIG. 7. However, in this case, the retrieval target image characteristic amount extraction unit 204 extracts the characteristic amount from the target partial area of the retrieval target image.

At step S257, the characteristic amount comparing unit 205 compares the characteristic amount of the key image with the characteristic amount of the retrieval target image in the same manner as the case of step S135 of FIG. 7. However, in this case, the characteristic amount comparing unit 205 compares the characteristic amounts with respect only to the target partial area.

The processes of steps S258 and S259 are respectively performed in the same manner as the processes of steps S136 and S137 in FIG. 7.

When the target partial area is specified based on only the characteristic amount of the key image, the area specifying unit 404 may specify the tap at step S253, and the process of step S254 may be omitted. Moreover, when the target partial area is specified based on only the user's instruction, the process of step S253 may be omitted, and the user instruction receiving unit 403 may receive the designated ranges of the target partial area at step S254.

As described above, when the characteristic amounts are compared with respect only to a predetermined partial area, it is necessary to extract the characteristic amounts of the retrieval target images and compare the characteristic amounts with respect only to the partial area. Thus, the imaging retrieval unit 161 is able to perform the imaging retrieval process more easily.

Moreover, since the area specifying unit 404 narrows down the target partial area candidates, the user is able to specify the target partial area more easily.

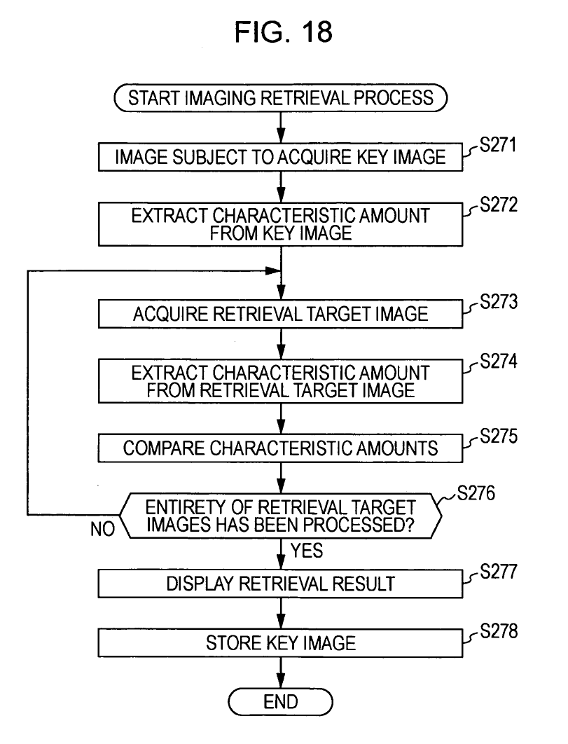

The retrieval result processing unit 206 may perform other processing rather than displaying the retrieval results on the display unit 125. For example, the retrieval result processing unit 206 may store the key images in the storage unit 124 as illustrated in FIG. 13. An example of the flow of the imaging retrieval process applicable to that case will be described with reference to the flowchart of FIG. 18. The flowchart of FIG. 18 corresponds to the flowchart of FIG. 7.

The processes of steps S271 to S277 in FIG. 18 are respectively performed in the same manner as the processes of steps S131 to S137 in FIG. 7. At step S278, the retrieval result processing unit 206 supplies the key images acquired at step S271 to the storage unit 124 to be stored therein. At this time, information such as the retrieval result may be added to be correlated with the key image. When the process of step S278 is terminated, the imaging retrieval process ends.

As described above, by storing the key images in the storage unit 124, the imaging retrieval unit 161 is able to use the key images in the subsequent processes. For example, the older images may be displayed on the display unit 125 as described above with reference to FIG. 10C.

Moreover, the retrieval result processing unit 206 may output information such as the key image or the retrieval results to an external device of the imaging apparatus 100 via the output unit 132.

Furthermore, the imaging retrieval unit 161 may create new contents such as a moving image or a slide show from the retrieval results and display the contents on the display unit 125 as the retrieval results.

In that comb-shaped electrode, the imaging retrieval unit 161 includes a contents generation unit 405. The contents generation unit 405 creates slide show contents using still images when a plurality of still images is obtained as the retrieval result, for example. In addition, the contents generation unit 405 creates one moving image contents using plural moving images when a plurality of moving images is obtained as the retrieval result, for example.

The retrieval result processing unit 206 displays the contents (slide show or moving image) created by the contents generation unit 405 on the display unit 125.

FIG. 12B illustrates an exemplary method of displaying moving image contents in which a plurality of scenes of each of a plurality of moving images retrieved as the retrieval results is integrated into one moving image. In the example of FIG. 12B, moving image contents 341 which are created using the retrieval results are displayed on the whole screen of the retrieval result screen 300. Moreover, moving images each containing a retrieved scene are represented as horizontal bars (horizontal bars 342 to 344) which are displayed so as to overlap the moving image contents 341. The hatched parts of each horizontal bar correspond to the retrieved scenes. The moving image contents 341 are created by integrating the hatched parts in the order indicated by the arrows.

By displaying new contents as the retrieval results in the described manner, the user is able to browse the retrieval results more easily, for example.

Furthermore, the imaging retrieval unit 161 may perform re-retrieval on the obtained retrieval results. For example, as illustrated in FIG. 13, the imaging retrieval unit 161 further includes a re-retrieval unit 406.

The re-retrieval unit 406 performs a process of performing re-retrieval on the retrieval results of the imaging retrieval. At this time, the retrieval result processing unit 206 displays a re-retrieve button on the display unit 125 together with the retrieval results, in which the re-retrieve button is a GUI for receiving a re-retrieval instruction from a user.

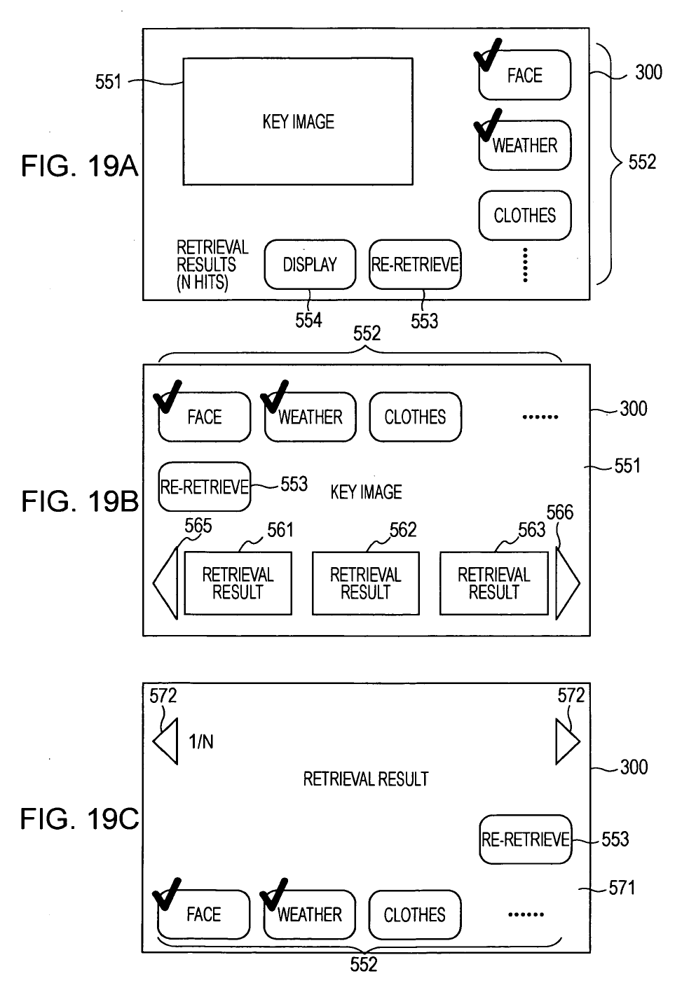

FIGS. 19A to 19C are schematic diagrams illustrating a method of displaying the retrieval results. For example, the retrieval result processing unit 206 displays a key image 551 on the retrieval result screen 300 as illustrated in FIG. 19A.

The retrieval result processing unit 206 further displays a condition specifying button 552 on the retrieval result screen 300, in which the condition specifying button is a list of retrieval conditions derived from the characteristic amount of the key image 551 and is a GUI for allowing the user to specify a retrieval condition to be used for the re-retrieval. In the example of FIG. 19A, buttons of “face”, “weather”, and “clothes” are displayed as the condition specifying button 552. These items can be derived from the characteristic amount of the key image 551, and when selected by the user, a check mark is inserted in the selected button, and an item corresponding to the button is added to the re-retrieval condition.

In the case of the example of FIG. 19A, the retrieval result processing unit 206 further displays a re-retrieve button 553 and a display button 554 on the retrieval result screen 300. When the user operates on the re-retrieve button 553, re-retrieval is performed. When the user operates on the display button 554, the current retrieval results are displayed.

FIG. 19B illustrates another exemplary method of displaying the retrieval results. In the case of the example of FIG. 19B, the key image 551 is displayed on the whole screen of the retrieval result screen 300, and a condition specifying button 552, a re-retrieve button 553, retrieval result images 561 to 563, and scroll buttons 565 and 566 are displayed so as to overlap the key image 551.

FIG. 19C illustrates a further example. In the case of the example of FIG. 19C, the retrieval result images are displayed one by one on the retrieval result screen 300. A retrieval result image 571 is displayed on the whole screen of the retrieval result screen 300, and a condition specifying button 552, a re-retrieve button 553, scroll buttons 572 and 573, and the like are displayed so as to overlap the retrieval result image 571.

On the retrieval result screen 300 having any of the described layouts, when the user operates on the re-retrieve button 553, the re-retrieval unit 406 supplies information such as, for example, the retrieval condition selected in response to the user's operation on the condition specifying button 552, the key image, and the retrieval result images, to the selective retrieval unit 162 so that image retrieval for the supplied key image is executed.

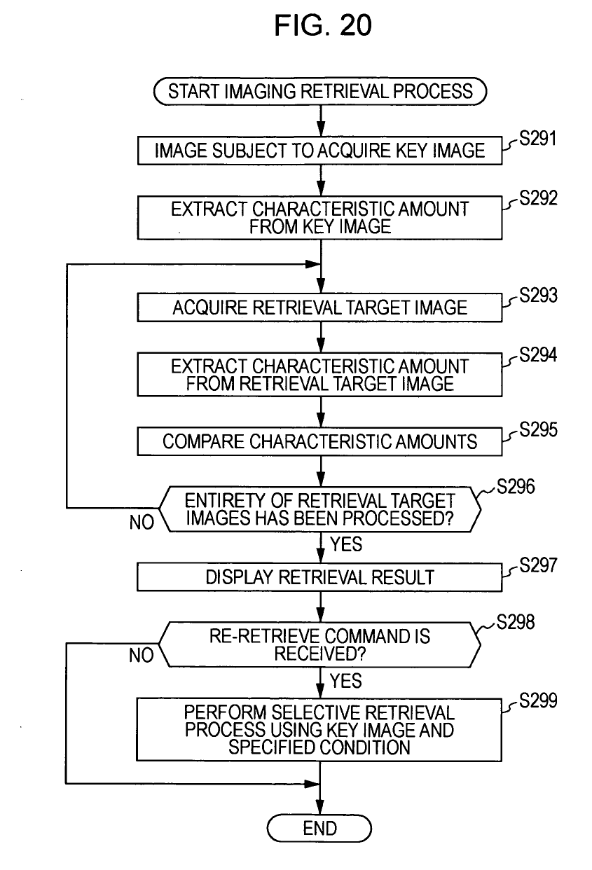

An example of the flow of the imaging retrieval process applicable to this case will be described with reference to the flowchart of FIG. 20. The flowchart of FIG. 20 corresponds to the flowchart of FIG. 7.

The processes of steps S291 to S297 in FIG. 20 are respectively performed in the same manner as the processes of steps S131 to S137 in FIG. 7. At step S298, the re-retrieval unit 406 determines whether or not a re-retrieval instruction is issued. When it is determined that a re-retrieval instruction is issued, the process flow proceeds to step S299.

At step S299, the selective retrieval unit 162 performs the selective retrieval process using the key image and a specified condition in the same manner as described with reference to the flowchart of FIG. 8, for example. However, in this case, the key image designated by the re-retrieval unit 406 is used as the key image.

When the process of step S299 is terminated, the imaging retrieval process ends. When it is determined at step S298 that the re-retrieval instruction is not issued, the imaging retrieval process ends while the process of step S299 is omitted.

By performing the re-retrieval in the described manner, the user is able to narrow down the retrieval results more easily. That is to say, the user is able to retrieve a desired image more easily.

### 2. Second Embodiment

### Overview of Image Retrieval System

Although it has been described for the case where the retrieval is performed with respect to the image data (images) recorded in the imaging apparatus, the retrieval may be performed with respect to the image data (images) stored outside the imaging apparatus.

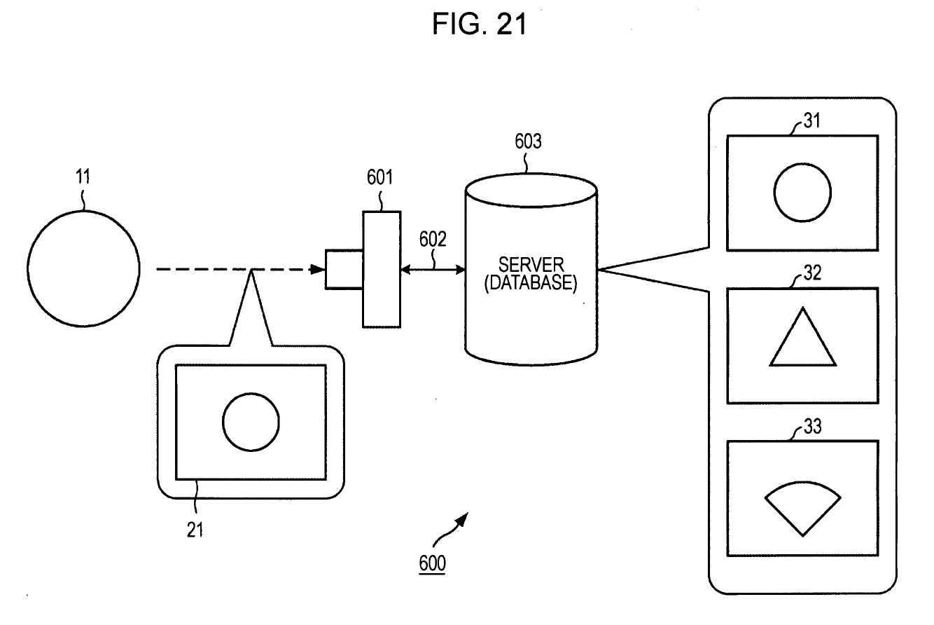

FIG. 21 is a schematic diagram illustrating an overview of an image retrieval system according to an embodiment of the present invention. For example, as illustrated in FIG. 21, the imaging apparatus may perform the retrieval with respect to the image data (images) registered in a server (database) connected via a network or the like.

The image retrieval system 600 illustrated in FIG. 21 is a system that performs image retrieval with respect to images 31 to 33 which are registered in a server 603 connected via a network 602 using an image 21 acquired by an imaging apparatus 601 imaging a subject 11 as a key image.

That is to say, the image retrieval system 600 is basically the same as the imaging apparatus 100 of FIG. 1 except that the images 31 to 33 used as the retrieval target are not registered in the storage unit of the imaging apparatus 601 but in the server 603.

Therefore, for example, the user operates the imaging apparatus 601 to image the subject 11 and obtains the image 21 in order to retrieve a desired image from the images registered in the server 603. When the acquired image 21 is obtained, the imaging apparatus 601 performs image retrieval with respect to the images (images 31 to 33) registered in the database of the server 603 using the acquired image 21 as a key image so as to retrieve the image 31 of which the characteristics are identical or similar to the characteristics of the acquired image 21.

The network 602 is an example of a communication medium, which may be a communication network such as LAN (local area network), a WAN (wide area network), or the Internet, and may be a cable such as a USB or an IEEE1349. Moreover, the network 602 may include wireless communications such as a wireless LAN or infrared-ray communications. Furthermore, the network 602 may be configured by a combination of a plurality of kinds of communications (communication medium) such as a combination of a wireless LAN and the Internet.

### Exemplary Configuration of Each Apparatus

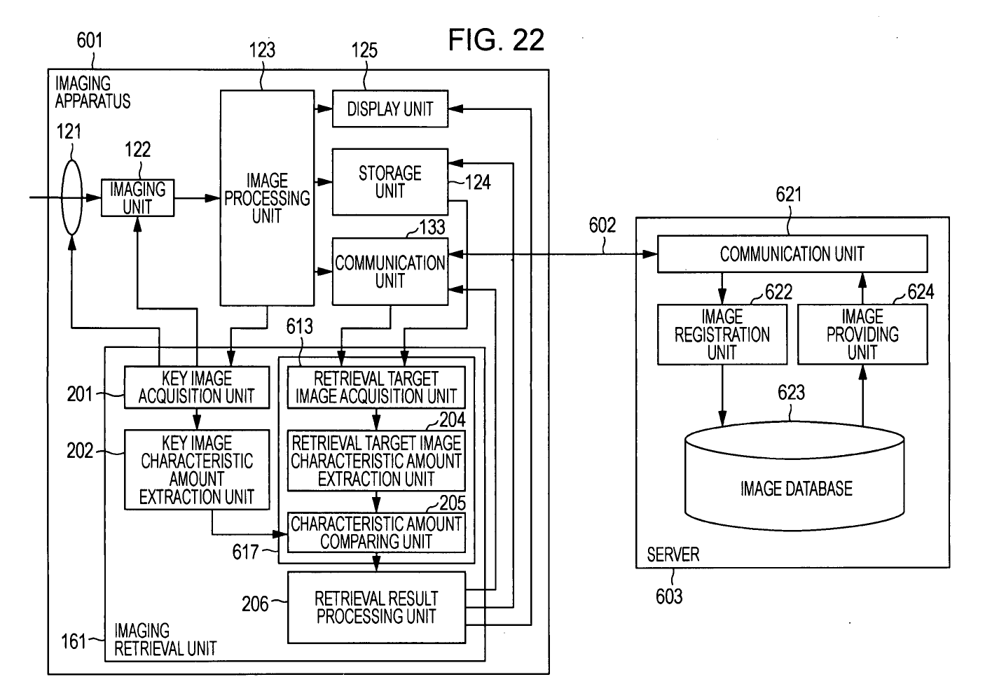

FIG. 22 is a block diagram illustrating an example of the main configuration of each apparatus of the image retrieval system 600 illustrated in FIG. 21.

As illustrated in FIG. 22, the imaging apparatus 601 basically has the same configuration as the imaging apparatus 100 illustrated in FIG. 2. Moreover, in this case, the imaging retrieval unit 161 basically has the same configuration as described with reference to FIG. 4. However, the imaging retrieval unit 161 of the imaging apparatus 601 has a rubbing treatment 613 in lieu of the retrieval target image acquisition unit 203 of FIG. 4.

The retrieval target image acquisition unit 613 is configured not only to acquire images from the storage unit 124 as the retrieval target images, via the communication unit 133 but also acquire images (image data) registered in an image database 623 of the server 603 as the retrieval target images.

In the imaging mode, the imaging apparatus 601 not only performs image processing on the images acquired by imaging a subject with the aid of the image processing unit 123, displays them on the display unit 125, and stores them in the storage unit 124, but also supplies them to the server 603 via the communication unit 133 to be registered in the image database 623. An imaging apparatus similar to the imaging apparatus 601 may register acquired images in the image database 623.

In the pickup retrieval mode, the retrieval target image acquisition unit 613 acquires not only the images of the image data stored in the storage unit 124 but also the images of the image data registered in the image database 623 as the retrieval target images. The retrieval target image acquisition unit 613 sends the acquired retrieval target images (image data) to the retrieval target image characteristic amount extraction unit 204.

The retrieval target image acquisition unit 613, the retrieval target image characteristic amount extraction unit 204, and the characteristic amount comparing unit 205 will be collectively referred to as a retrieval unit 617. That is to say, the retrieval unit 617 retrieves a desired image from at least one of the images of the image data stored in the storage unit 124 and the images of the image data registered in the image database 623 using the characteristic amount of the key image.

The server 603 connected to the imaging apparatus 601 via the network 602 includes a communication unit 621, an image registration unit 622, the image database 623, and an image providing unit 624.

The communication unit 621 is a processor corresponding to the communication unit 133 of the imaging apparatus 601. The communication unit 621 communicates with the communication unit 133 via the network 602 so as to transmit/receive various kinds of information such as image data or control command.

The image registration unit 622 supplies the image data of the acquired images supplied from the imaging apparatus 601 via the communication unit 621 to the image database 623 to be registered therein. The image database 623 is configured by a storage area of a predetermined storage medium such as a hard disk or a flash memory and is a database that manages the acquired images supplied from the imaging apparatus 601 or the like. The image providing unit 624 reads the images (image data) stored in the image database 623 and supplies the images to the communication unit 621. For example, the image providing unit 624 reads the retrieval target images from the image database 623 based on a request supplied from the imaging apparatus 601 via the communication unit 621 and supplies the retrieval target images to the communication unit 621.

The communication unit 621 supplies the retrieval target images (image data) supplied from the image providing unit 624 to the imaging apparatus 601 (the communication unit 133) using the network 602.

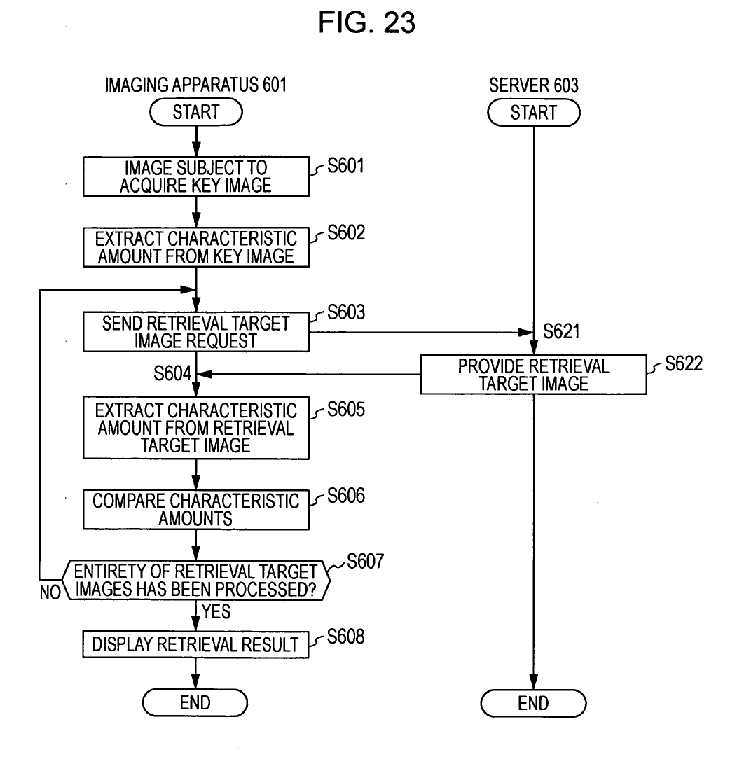

Next, an example of the flowchart of the imaging retrieval process in such an image retrieval system 600 will be described with reference to the flowchart of FIG. 23. This flowchart corresponds to the flowchart of FIG. 7. Therefore, the processes of steps S601 and S602 are respectively performed in the same manner as the processes of steps S131 and S132 in FIG. 7.

At step S603, the retrieval target image acquisition unit 613 controls the communication unit 133 to send a retrieval target image request to the server 603. Upon receiving the request at step S621, the image providing unit 624 of the server 603 acquires the image data from the image database 623 and supplies the images (image data) as the retrieval target images to the imaging apparatus 601 via the communication unit 621 at step S622. The retrieval target image acquisition unit 613 acquires the retrieval target images via the communication unit 133 at step S604.

That is to say, the above-described processes are performed in lieu of the process of step S133 in FIG. 7.

Upon acquiring the retrieval target images, the imaging apparatus 601 performs the processes of steps S605 to S608 in the same manner as the steps S134 to S137 in FIG. 7, respectively.

By doing so, the user is easily able to retrieve a desired image even when retrieval is performed with respect to images which are registered in the server 603 outside the imaging apparatus 601.

The retrieval result processing unit 206 of the imaging apparatus 601 may supply the retrieval results or the key image to the server 603 via the communication unit 133 to be registered in the image database 623.

### Another Exemplary Configuration of Each Apparatus

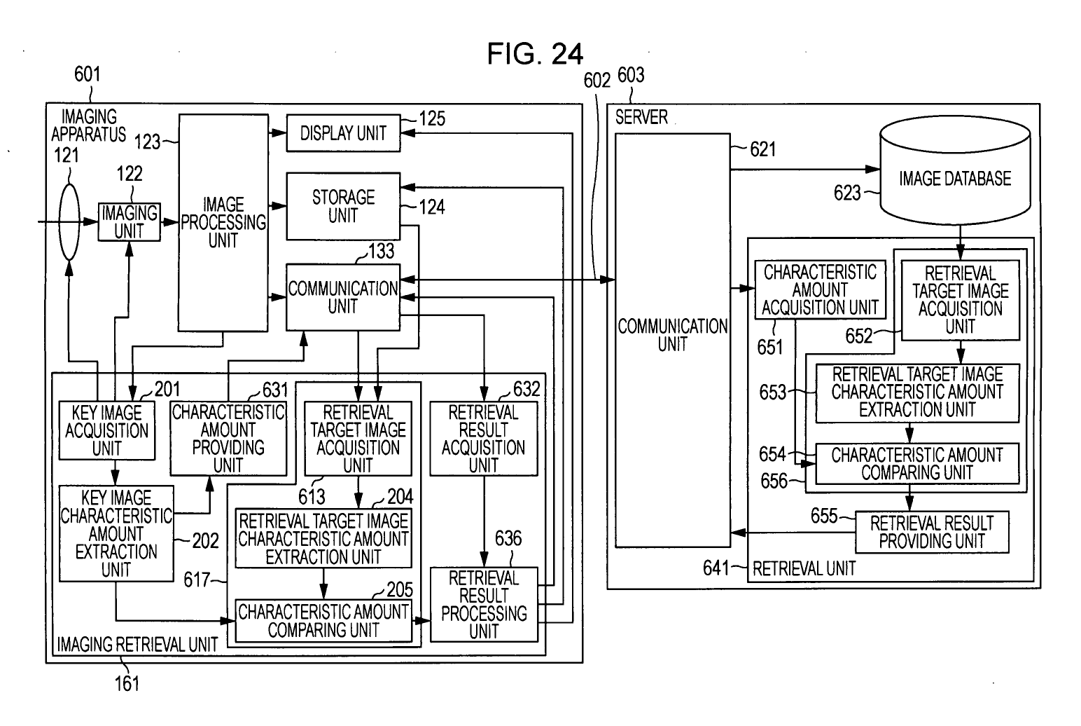

The server 603 may perform image retrieval using an image acquired by imaging a subject. FIG. 24 is a block diagram illustrating a modified example of the configuration of each apparatus of the image retrieval system 600 applicable to that case.

In the case of FIG. 24, the imaging retrieval unit 161 of the imaging apparatus 601 includes a characteristic amount providing unit 631 and a retrieval result acquisition unit 632 in addition to the configuration described with reference to FIG. 22.

The characteristic amount providing unit 631 acquires the characteristic amount of the key image extracted by the key image characteristic amount extraction unit 202 and controls the communication unit 133 to supply the characteristic amount to the server 603. When there is additional information necessary for comparing the characteristic amounts in addition to the characteristic amount of the key image, the characteristic amount providing unit 631 supplies that information to the server 603 via the communication unit 133 together with the characteristic amount of the key image. For example, when the imaging retrieval unit 161 has the area specifying unit 404 and compares the characteristic amounts with respect only to a partial area (target partial area) as described above, the characteristic amount providing unit 631 acquires information on the target partial area and supplies the information to the server 603 via the communication unit 133. Moreover, for example, the characteristic amount providing unit 631 may acquire the image data of the key image together with the characteristic amount of the key image and supply the image data to the server 603 via the communication unit 133.

The server 603 performs image retrieval using the characteristic amount of the key image supplied by the characteristic amount providing unit 631 and transmits the retrieval results to the imaging apparatus 601. The retrieval result acquisition unit 632 controls the communication unit 133 to acquire the retrieval results supplied from the server 603. The retrieval results are basically the same as the retrieval results output by the characteristic amount comparing unit 205 and include the image data of the retrieval target images of which the characteristic amounts are determined to be identical or similar to the characteristic amount of the key image based on the comparison results of the characteristic amount. Moreover, the retrieval results may include the image data of the key image or the characteristic amount. The retrieval result acquisition unit 632 supplies the retrieval results to the retrieval result processing unit 636.

In the case of FIG. 24, the imaging retrieval unit 161 includes a retrieval result processing unit 636 in lieu of the retrieval result processing unit 206 illustrated in FIG. 22. The retrieval result processing unit 636 processes not only the retrieval results supplied from the characteristic amount comparing unit 205 but also the retrieval results supplied from the retrieval result acquisition unit 632. That is to say, the retrieval result processing unit 636 may display the retrieval results on the display unit 125, store them in the storage unit 124, and supply them to the server 603 via the communication unit 133 to be registered in the image database 623. Moreover, the retrieval result processing unit 636 may store the image data of the key image used for the image retrieval in the storage unit 124 and supply them to the server 603 via the communication unit 133 to be registered in the image database 623.

The server 603 includes a retrieval unit 641 in addition to the communication unit 621 and the image database 623. The retrieval unit 641 acquires the characteristic amount of the key image supplied from the imaging apparatus 601 via the communication unit 621. The retrieval unit 641 performs image retrieval with respect to the images registered in the image database 623 using the acquired characteristic amount. The retrieval unit 641 supplies the retrieval results to the imaging apparatus 601 via the communication unit 621.

The retrieval unit 641 includes a characteristic amount acquisition unit 651, a retrieval target image acquisition unit 652, a retrieval target image characteristic amount extraction unit 653, a characteristic amount comparing unit 654, and a retrieval result providing unit 655.

The characteristic amount acquisition unit 651 acquires the characteristic amount extraction unit of the key image supplied from the imaging apparatus 601 via the communication unit 621. When additional information is supplied together with the characteristic amount of the key image from the imaging apparatus 601, the characteristic amount acquisition unit 651 also acquires the additional information. The characteristic amount acquisition unit 651 supplies the acquired information to the characteristic amount comparing unit 654.

The retrieval target image acquisition unit 652 is a processor corresponding to the retrieval target image acquisition unit 613 and basically operates in the same manner as the retrieval target image acquisition unit 613. The retrieval target image acquisition unit 652 acquires the images (image data) registered in the image database 623 as retrieval target images. The retrieval target image acquisition unit 652 supplies the acquired retrieval target images (the image data thereof) to the retrieval target image characteristic amount extraction unit 653.

The retrieval target image characteristic amount extraction unit 653 is a processor corresponding to the retrieval target image characteristic amount extraction unit 204 and basically operates in the same manner as the retrieval target image characteristic amount extraction unit 204. The retrieval target image characteristic amount extraction unit 653 extracts characteristic amounts from the retrieval target images (the image data thereof) supplied from the retrieval target image acquisition unit 652. The retrieval target image characteristic amount extraction unit 653 supplies the extracted characteristic amounts of the retrieval target images to the characteristic amount comparing unit 654.

The characteristic amount comparing unit 654 is a processor corresponding to the characteristic amount comparing unit 205 and basically operates in the same manner as the characteristic amount comparing unit 205. The characteristic amount comparing unit 654 compares the characteristic amount of the key image with the characteristic amount of the retrieval target images to determine whether or not the characteristics of the retrieval target images are identical or similar to the characteristics of the key image. The characteristic amount comparing unit 654 performs the comparing of the characteristic amount with respect to the entirety of retrieval target images and supplies the results to the retrieval result providing unit 655 as the retrieval results.

The retrieval result providing unit 655 supplies the retrieval results supplied from the characteristic amount comparing unit 654 to the imaging apparatus 601 via the communication unit 621. The retrieval results include the image data or characteristic amounts of the retrieval target image of which the characteristics are determined to be identical or similar to the characteristics of the key image, information on the target partial area, and information on other retrieval conditions, for example.

The retrieval target image acquisition unit 652, the retrieval target image characteristic amount extraction unit 653, and the characteristic amount comparing unit 654 will be collectively referred to as a retrieval unit 656. That is to say, the retrieval unit 656 retrieves a desired image from the images of the image data registered in the image database 623 using the characteristic amount of the key image.

As described above, in the case of the image retrieval system 600 illustrated in FIG. 24, both the imaging apparatus 601 and the server 603 performs image retrieval using the acquired images obtained by the imaging apparatus 601 as the key image. More specifically, the imaging apparatus 601 performs image retrieval with respect to the images stored in the storage unit 124 of the imaging apparatus 601, and the server 603 performs image retrieval with respect to the images registered in the image database 623 of the server 603.

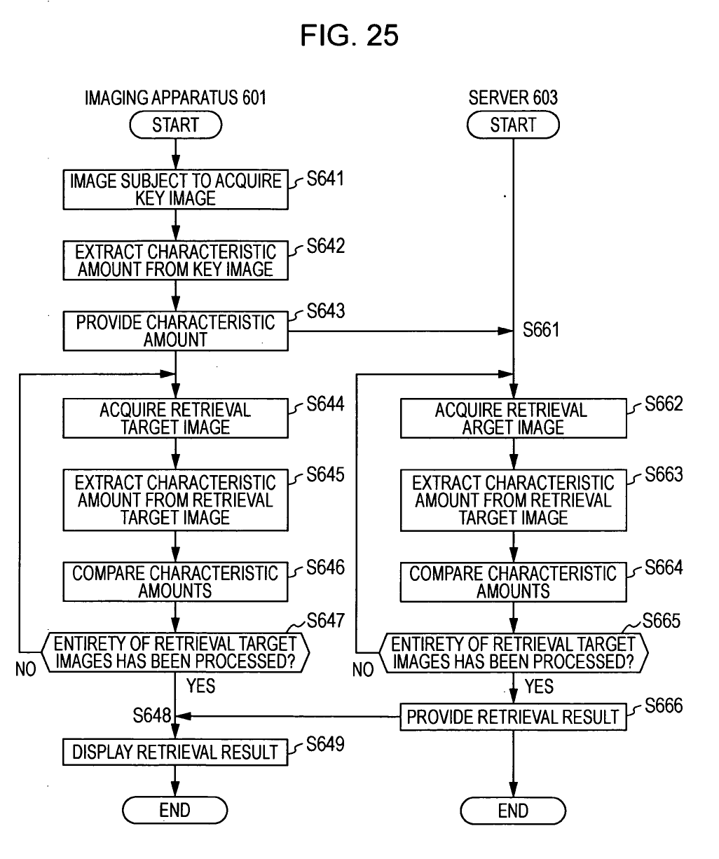

FIG. 25 is a flowchart illustrating the image retrieval process executed by such an image retrieval system 600. This flowchart corresponds to the flowchart of FIG. 7.

When the image retrieval process is started, the imaging apparatus 601 performs the processes of steps S641 and S642 in the same manner as the steps S131 and S132 in FIG. 7, respectively. At step S643, the characteristic amount providing unit 631 of the imaging apparatus 601 supplies the characteristic amount of the key image extracted at step S132 to the server 603 via the communication unit 133. At step S661, the characteristic amount acquisition unit 651 of the server 603 acquires the characteristic amount of the key image via the communication unit 621.

The imaging apparatus 601 having supplied the characteristic amount of the key image performs the processes of steps S644 to S647 in the same manner as the processes of steps S133 to S136 in FIG. 7, respectively. Moreover, the server 603 having acquired the characteristic amount of the key image performs the processes of steps S662 to S665 in the same manner as the processes of steps S644 to S647, respectively. However, the server 603 performs the above-described processes with respect to the images registered in the image database 623.

At step S666, the retrieval result providing unit 655 of the server 603 supplies the retrieval results obtained by the preceding processes up to step S665 to the imaging apparatus 601 via the communication unit 621. At step S648, the retrieval result acquisition unit 632 of the imaging apparatus 601 acquires the retrieval results by controlling the communication unit 133.

At step S649, the retrieval result processing unit 636 of the imaging apparatus 601 displays the retrieval results on the display unit 125.

As described above, since the image retrieval is performed by both the imaging apparatus 601 and the server 603, the image retrieval system 600 is able to perform the image retrieval using the acquired images as the key image with respect to both the images stored in the storage unit 124 and the images registered in the image database 623. By doing so, the user is easily able to retrieve a desired image from a larger number of images.

### 3. Third Embodiment

### Exemplary Configuration of Each Apparatus

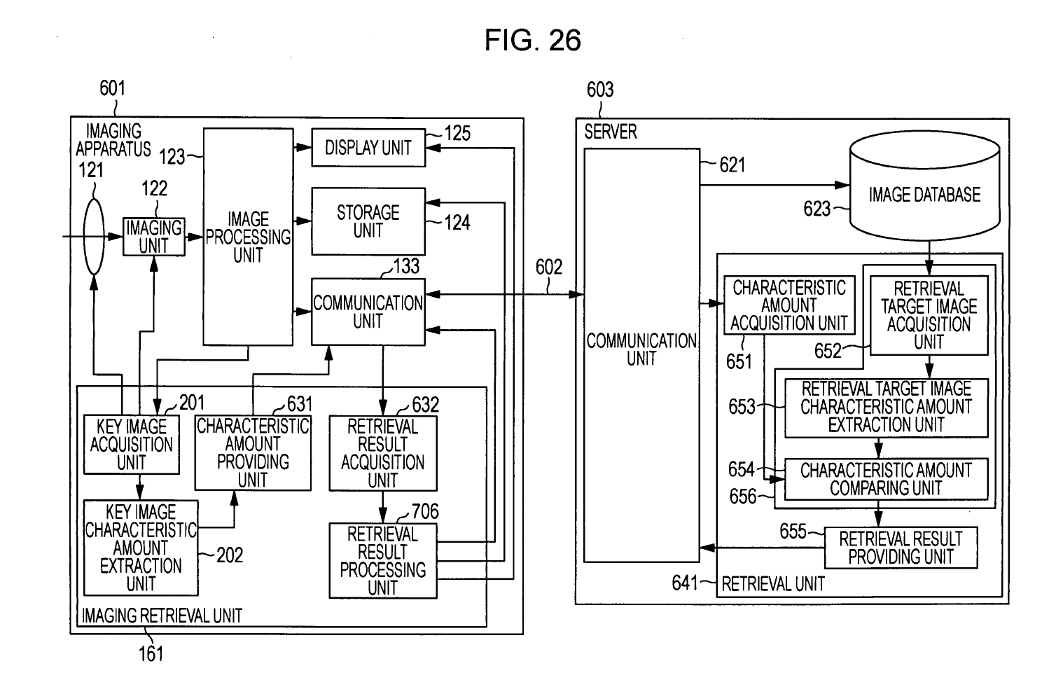

The image retrieval may be performed by just the server 603. FIG. 26 is a block diagram illustrating another example of the main configuration of each apparatus of the image retrieval system 600.

In the configuration of the imaging retrieval unit 161 of the imaging apparatus 601 illustrated in FIG. 26, the retrieval target image acquisition unit 613, the retrieval target image characteristic amount extraction unit 204, and the characteristic amount comparing unit 205 are omitted from the configuration illustrated in FIG. 24. Therefore, the imaging retrieval unit 161 does not perform image retrieval. That is to say, the information such as the characteristic amount of the key image extracted by the key image characteristic amount extraction unit 202 is only supplied by the characteristic amount providing unit 631 to the server 603 via the communication unit 133.

Moreover, the imaging retrieval unit 161 illustrated in FIG. 26 includes a retrieval result processing unit 706 in lieu of the retrieval result processing unit 636 illustrated in FIG. 24. The retrieval result processing unit 706 processes only the retrieval results acquired by the retrieval result acquisition unit 632. That is to say, the retrieval result processing unit 706 displays the retrieval results of the image retrieval performed by the server 603 on the display unit 125, stores them in the storage unit 124, and supplies them to the server 603 or the like via the communication unit 133.

The configuration of the server 603 illustrated in FIG. 26 are the same as the case of FIG. 24. Therefore, the processes executed by the server 603 illustrated in FIG. 26 are the same as the case of FIG. 24.

Another Exemplary Configuration of Each Apparatus

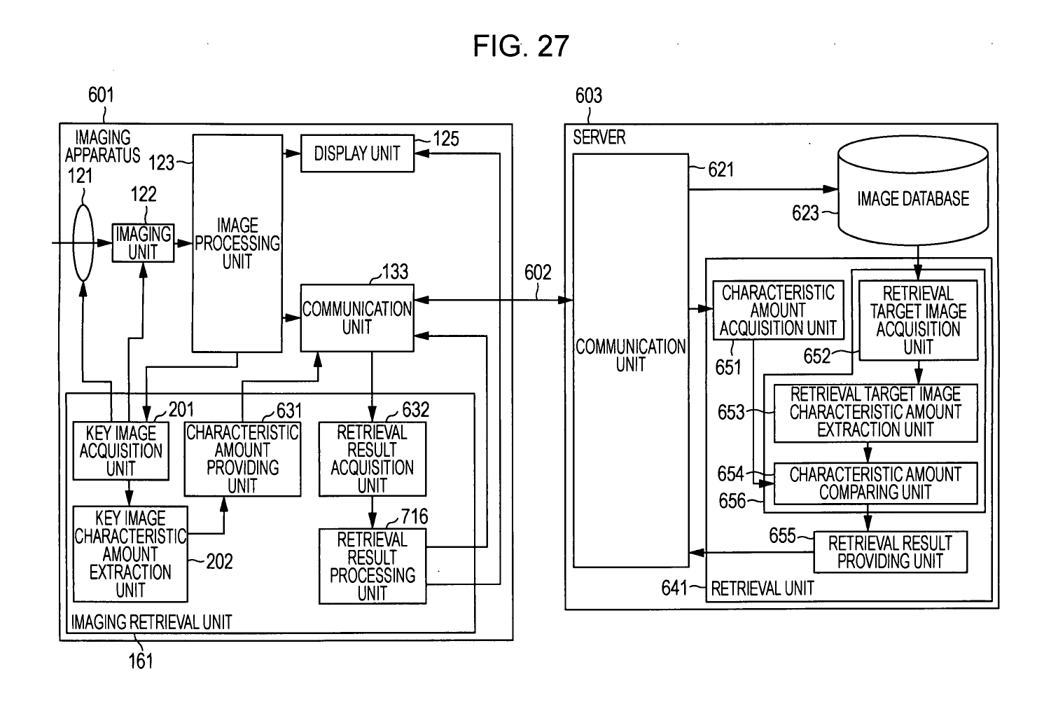

The storage unit 124 of the imaging apparatus 601 may be omitted. FIG. 27 is a block diagram illustrating a modified example of the configuration of each apparatus.

The configuration of the imaging retrieval unit 161 of the imaging apparatus 601 illustrated in FIG. 27 is basically the same as the configuration illustrated in FIG. 26. However, the imaging retrieval unit 161 includes a retrieval result processing unit 716 in lieu of the retrieval result processing unit 706. The retrieval result processing unit 716 displays the retrieval results on the display unit 125 and supplies them to the server 603 or the like via the communication unit 133. However, since the imaging apparatus 601 does not have the storage unit 124, the retrieval result processing unit 716 does not supply the retrieval results, the key image, and the like to the storage unit 124.

The configuration of the server 603 illustrated in FIG. 27 is the same as the case of FIG. 26.

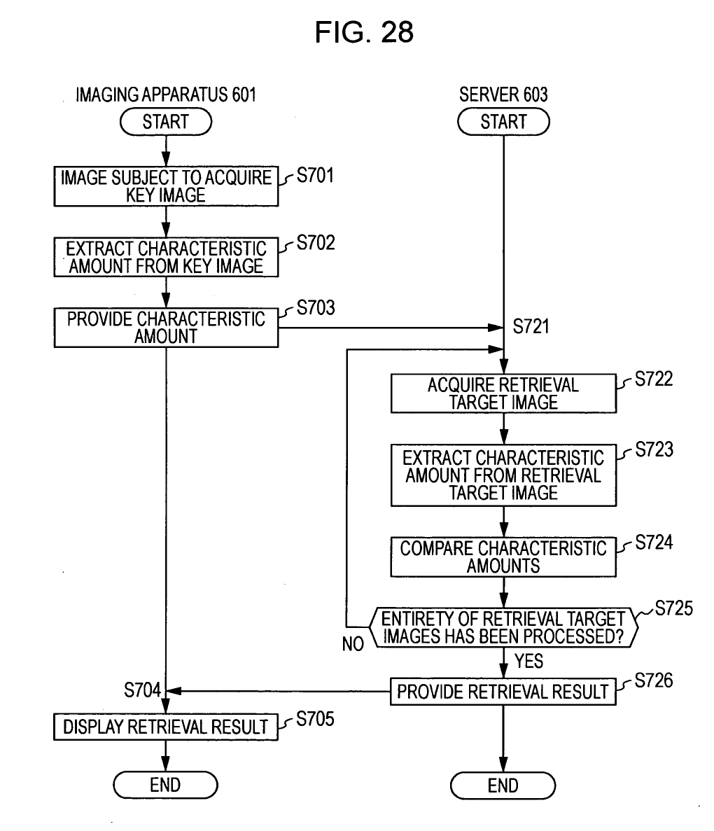

FIG. 28 is a flowchart illustrating the image retrieval process executed by the image retrieval system 600 illustrated in FIG. 26 or 27. This flowchart corresponds to the flowchart of FIG. 7.

When the image retrieval process is started, the imaging apparatus 601 performs the processes of steps S701 and S702 in the same manner as the steps S131 and S132 in FIG. 7, respectively. At step S703, the characteristic amount providing unit 631 of the imaging apparatus 601 supplies the characteristic amount of the key image extracted at step S132 to the server 603 via the communication unit 133. At step S721, the characteristic amount acquisition unit 651 of the server 603 acquires the characteristic amount of the key image via the communication unit 621.

The server 603 having acquired the characteristic amount of the key image performs the processes of steps S722 to S725 in the same manner as the processes of steps S133 to S136 in FIG. 7, respectively. However, the server 603 performs the above-described processes with respect to the images registered in the image database 623.

At step S726, the retrieval result providing unit 655 of the server 603 supplies the retrieval results obtained by the preceding processes up to step S725 to the imaging apparatus 601 via the communication unit 621. At step S704, the retrieval result acquisition unit 632 of the imaging apparatus 601 acquires the retrieval results by controlling the communication unit 133.

At step S705, the retrieval result processing unit 636 of the imaging apparatus 601 displays the retrieval results on the display unit 125.

The flow of the image retrieval process executed by the image retrieval system illustrated in FIG. 26 is the same as the flow of the flowchart illustrated in FIG. 25, except that the processes of steps S644 to 5647 are omitted.

As described above, since the image retrieval is executed by the server 603, the imaging apparatus 601 is able to omit the image retrieval process, whereby the power consumption of the imaging apparatus 601 can be reduced, and the manufacturing cost of the imaging apparatus 601 can be reduced. Moreover, when the configuration as illustrated in FIG. 27 is used, the imaging apparatus 601 is able to omit the storage unit 124 and reduce manufacturing costs.

In the above description, the present invention has been described by way of the imaging apparatuses 100 and 601 which are configured by a digital camera or a camcorder, for example. However, this is an exemplary embodiment only, and the present invention can be applied to any apparatus as long as it is capable of performing image retrieval using the characteristic amount of a key image. For example, the apparatus may be a viewer (image display apparatus) such as a digital photo frame and may be a general-purpose information processing apparatus such as a personal computer. Moreover, the apparatus may perform only the image retrieval using the characteristic amount of a key image. Furthermore, the apparatus may cause another apparatus to perform a part or an entirety of the processes of acquiring the key image, extracting the characteristic amount, storing the retrieval target images, and displaying the retrieval results.

The above-described series of processings can be executed not only by hardware but also by software. When the series of processings is executed by software, a program included in the software is installed via a network or a recording medium.

For example, the recording medium may be configured by the removable medium 141 which is provided separately from an apparatus body and records therein a program which is distributed so as to deliver a program to the administrator of the imaging apparatus 100 (the imaging apparatus 601) as illustrated in FIG. 2 and may be configured by a ROM of the control unit 111 or a hard disk included in the storage unit 124, which is delivered to the administrator in a state of being incorporated into the apparatus body.

Alternatively, the program may be provided via wired or wireless transmission media such as local area network, the Internet, digital satellite broadcasting. In this case, the program is received by the communication unit 133 via wired or wireless transmission media and installed in the storage unit 124 or the like.

The program executed by the computer may be a program executing processing in a time-sequential manner in accordance with the procedures described in this specification and may be a program executing the processing in a parallel manner or at necessary times such as in response to calls.

Here, in this specification, the steps that describe the program recorded in the recording medium include not only processing which is executed in time-sequential manner in accordance with described procedures but also processing which is executed in parallel and/or separately even if it is not executed in time-sequential manner.

In this specification, the term “system” is used to imply an apparatus as a whole, which includes a plurality of devices and units.

The present application contains subject matter related to that disclosed in Japanese Priority Patent Application JP 2009-017633 filed in the Japan Patent Office on Jan. 29, 2009, the entire content of which is hereby incorporated by reference.

In the above description, the configuration described as one apparatus (or processor) may be split into a plurality of apparatuses (or processors). Alternatively, the configuration described as a plurality of apparatuses (or processors) may be integrated into a single apparatus (or processor). Moreover, a configuration other than those discussed above may be included in the above-described configuration of each apparatus (or each processor). If the configuration and the operation of a system as a whole is substantially the same, part of the configuration of an apparatus (or processor) may be added to the configuration of another apparatus (or another processor). The embodiments of the present invention are not limited to the above-described embodiments, but various modifications can be made in a range not departing from the gist of the present invention.

What is claimed is:

1. An imaging apparatus comprising:
image acquisition means for acquiring an image by imaging a subject to output an acquired image;
acquired image characteristic amount extraction means for extracting a characteristic amount of the acquired image acquired by the image acquisition means; and
retrieval means for retrieving images of which the characteristics are identical or similar to the characteristics of the acquired image from other images other than the acquired image using the characteristic amount extracted by the acquired image characteristic amount extraction means.

2. The imaging apparatus according to claim 1,
wherein the retrieval means includes:
retrieval target image acquisition means for acquiring the other images as retrieval target images;
retrieval target image characteristic amount acquisition means for extracting a characteristic amount of the retrieval target images acquired by the retrieval target image acquisition means; and
comparing means for comparing the characteristic amount of the acquired image and the characteristic amount of the retrieval target images.

3. The imaging apparatus according to claim 1, further comprising receiving means for receiving a user's instruction,
wherein the image acquisition means images the subject in accordance with the user's instruction.

4. The imaging apparatus according to claim 1, further comprising image analysis means for analyzing the acquired image,
wherein the image acquisition means images the subject in accordance with the analysis results of the image analysis means.

5. The imaging apparatus according to claim 1, further comprising area specifying means for specifying a partial area for which the characteristic amount is compared,
wherein the retrieval means retrieves images of which the characteristics in the partial area are identical or similar to the characteristics of the acquired image from the other images using the characteristic amount in the partial area.

6. The imaging apparatus according to claim 5, further comprising receiving means for receiving a user's instruction,
wherein the area specifying means sets areas having predetermined characteristics as candidates for the partial area based on the characteristic amount extracted by the acquired image characteristic amount extraction means and specifies an area selected from the candidates by the user's instruction as the partial area.

7. The imaging apparatus according to claim 5, wherein the area specifying means specifies the partial area having predetermined characteristics based on the characteristic amount extracted by the acquired image characteristic amount extraction means.

8. The imaging apparatus according to claim 5, further comprising receiving means for receiving a user's instruction,
wherein the area specifying means specifies an area designated by the user's instruction as the partial area.

9. The imaging apparatus according to claim 1, further comprising result displaying means for displaying a result of the retrieval by the retrieval means.

10. The imaging apparatus according to claim 1, further comprising re-retrieval means for retrieving images of which the characteristics are identical or similar to the characteristics of the acquired image from the images retrieved by the retrieval means using another characteristic amount.

11. A retrieval method comprising the steps of:
acquiring an image by imaging a subject to output an acquired image;
extracting a characteristic amount of the acquired image; and
retrieving images of which the characteristics are identical or similar to the characteristics of the acquired image from other images other than the acquired image using the characteristic amount.

12. A program for causing a computer to execute a retrieval method comprising the steps of:
acquiring an image by imaging a subject to output an acquired image;
extracting a characteristic amount of the acquired image; and
retrieving images of which the characteristics are identical or similar to the characteristics of the acquired image from other images other than the acquired image using the characteristic amount.

13. An imaging apparatus comprising:
an image acquisition mechanism configured to acquire an image by imaging a subject to output an acquired image;
an acquired image characteristic amount extraction mechanism configured to extract a characteristic amount of the acquired image acquired by the image acquisition mechanism; and
a retrieval mechanism configured to retrieve images of which the characteristics are identical or similar to the characteristics of the acquired image from other images other than the acquired image using the characteristic amount extracted by the acquired image characteristic amount extraction mechanism.
